(19) United States
(12) Patent Application Publication
(10) Pub. No.: US 2011/0240127 A1
(43) Pub. Date: Oct. 6, 2011

(54) Fluidic Article Fabricated In One Piece

(75) Inventors: David Eberhart, Santa Clara, CA (US); Ezra Van Gelder, Palo Alto, CA (US)

(73) Assignee: INTEGENX INC., Pleasanton, CA (US)

(21) Appl. No.: 13/075,165

(22) Filed: Mar. 29, 2011

Related U.S. Application Data
(60) Provisional application No. 61/320,624, filed on Apr. 2, 2010.
(60) Provisional application No. 61/330,154, filed on Apr. 30, 2010.

(51) Int. Cl. F15D 1/00; B32B 1/00; B32B 3/30

(52) U.S. Cl. 137/1; 428/34.1; 428/36.92; 137/561 R

(57) ABSTRACT

In one aspect this invention provides an article fabricated in one piece comprising at least one aperture through the piece, wherein the aperture defines a non-microfluidic volume, and a microfluidic channel formed in a surface of the piece onto which the aperture opens, wherein the channel is in fluidic communication with the aperture, wherein the aperture and the microfluidic channel define a fluidic circuit.

### CROSS-REFERENCE

This application corresponds to and claims the benefit of the filing dates of U.S. provisional patent applications 61/320,624, filed Apr. 2, 2010 and 61/330,154, filed Apr. 30, 2010, both of which are incorporated herein by reference in their entirety.

### STATEMENT AS TO FEDERALLY SPONSORED RESEARCH

None.

### BACKGROUND OF THE INVENTION

Mathies et al. (U.S. Patent Publication 2004-0209354, Oct. 21, 2004) describes a microfluidic structure comprising: a first surface including a pneumatic channel; a second surface including a fluidic channel; and an elastomer membrane located between the first and second surfaces such that the application of a pressure or a vacuum to the pneumatic channel causes the membrane to deflect to modulate a flow of a fluid in the fluidic channel. Fluid flow in a fluidic conduit of such devices can be regulated by a diaphragm valve in the conduit that comprises a valve seat on which the elastomer membrane sits. When in contact with the seat, the elastomer membrane blocks fluid flow across a fluidic conduit. When out of contact with the seat, a passage exists that allows fluid communication across the valve. Mathies et al. indicates that the device can have surfaces of glass plastic or polymer.

Dubrow et al. (U.S. Pat. No. 6,251,343) describes microfluidic devices that comprise a body structure comprising at least a first microscale channel network disposed therein. The body structure has a plurality of ports disposed in the body structure, where each port is in fluid communication with one or more channels in the first channel network. The devices also include a cover layer comprising a plurality of apertures disposed through the cover layer. The cover layer is mated with the body structure whereby each of the apertures is aligned with a separate one of the plurality of ports.

Anderson et al. (Nucleic Acids Res. 2000 Jun. 15; 28(12):E60) describes a plastic device held together using ultrasonic welding or adhesives.

Jovanovich et al. (U.S. Patent Publication 2005/0161669, Jul. 28, 2005) describes reducing macroscale sample solutions to microscale volumes, for example by concentrating milliliters to microliters or smaller volumes for introduction into one or more microfluidic devices. It describes embodiments capable of acting as modular scale interfaces, permitting microscale and/or nanoscale devices to be integrated into fluidic systems that comprise operational modules that operate at larger scale.

Jovanovich et al. (WO 2008/115626, Sep. 25, 2008) describes microfluidic chips made from plastic components. It also describes integration of macroscale devices such as automation and robotics with nanoscale sample preparation and analysis.

### SUMMARY OF THE INVENTION

In one aspect this invention provides an article fabricated in one piece comprising at least one aperture through the piece, wherein the aperture defines a non-microfluidic volume, and a microfluidic channel formed in a surface of the piece onto which the aperture opens, wherein the channel is in fluidic communication with the aperture, wherein the aperture and the microfluidic channel define a fluidic circuit. In one embodiment the article comprises a polymer. In another embodiment the polymer is a polycarbonate, an olefin co-polymer (COC) (e.g., Zeonor), a cycloolefin co-polymer (COP), an acrylic, a liquid crystal polymer, polymethylmethoxyacrylate (PMMA), a polystyrene, a polypropylene, or a polythiol. In another embodiment the microfluidic channel is disposed on a surface of the article adapted for contact with an elastic layer for sealing the microfluidic channel. In another embodiment the surface adapted for contact is substantially planar. In another embodiment the surface adapted for contact comprises a non-smooth and/or patterned, surface. In another embodiment the article comprises a first side and a second side oriented substantially opposite each other, wherein the aperture communicates between the two sides. In another embodiment the aperture opens onto a surface that comprises elements that increase the rigidity of the article. In another embodiment the fluidic circuit further comprises a second aperture through the piece, the second aperture defining a non-microfluidic volume, wherein the second aperture is in fluidic communication with the microfluidic channel. In another embodiment the article comprises a plurality of fluidic circuits. In another embodiment the fluidic circuit further comprises a non-microfluidic compartment formed in a side of the article comprising the microfluidic channel. In another embodiment the aperture defines a volume of at least 5 microliters, at least 10 microliters, at least 50 microliters, at least 100 microliters, at least 500 microliters or at least one milliliter. In another embodiment the microfluidic channel comprises at least one interruption configured as a valve seat. In another embodiment the microfluidic channel comprises at least one concavity configured to accept a diaphragm. In another embodiment the aperture has an axial dimension that is at least three times longer than an average radial dimension. In another embodiment the article comprises a plurality of second apertures. In another embodiment the apertures are configured to be compatible with probes of a fluidic robot. In another embodiment a set of the apertures are configured to have a pitch of about 9 mm. In another embodiment the plurality of fluidic circuits are in communication with a fluidic bus formed in the first surface, wherein the bus comprises at least one aperture through the structure.

In another aspect this invention provides a device comprising: an article fabricated in one piece comprising at least one aperture through the piece, wherein the aperture defines a non-micro fluidic volume, and a microfluidic channel formed in a surface of the piece onto which the aperture opens, wherein the channel is in fluidic communication with the aperture, wherein the aperture and the microfluidic channel define a fluidic circuit; and an elastic layer covering and sealing the microfluidic channel. In one embodiment the elastic layer comprises a material selected from silicones (e.g., polydimethylsiloxane), polyimides (e.g., Kapton™, Ultem), cyclic olefin co-polymers (e.g., Topas™, Zeonor), rubbers (e.g., natural rubber, buna, EPDM), styrenic block co-polymers (e.g., SEBS), urethanes, perfluoro elastomers (e.g., Teflon, PFPE, Kynar), Mylar, Viton, polycarbonate, polymethylmethacrylate, santoprene, polyethylene, and polypropylene. In another embodiment the device further comprises particles responsive to a magnetic force disposed in the aperture. In another embodiment at least one fluidic channel comprises a valve seat. In another embodiment the device further comprises: c) an actuation piece having an actuation surface having an actuation channel therein, wherein the actuation surface contacts the elastic layer so that the elastic layer covers and seals the actuation channel and wherein the actuation channel is configured to transmit positive or negative pressure to the elastic layer opposite a valve seat in the fluidic structure. In another embodiment the valve is a normally open valve. In another embodiment the valve is a normally closed valve. In another embodiment the device comprises a pair of valves in series configured to deliver defined volumes of liquid.

In another aspect this invention provides an instrument comprising: a device comprising: an article fabricated in one piece comprising at least one aperture through the piece, wherein the aperture defines a non-microfluidic volume, and a microfluidic channel formed in a surface of the piece onto which the aperture opens, wherein the channel is in fluidic communication with the aperture, wherein the aperture and microfluidic channel define a fluidic circuit; an elastic layer covering and closing the microfluidic channel and configured to inhibit leaks of fluid from the microfluidic channel; and an actuation piece having an actuation surface having an actuation channel therein, wherein the actuation surface contacts the elastic layer so that the elastic layer covers and seals the actuation channel and wherein the actuation channel is configured to transmit positive or negative pressure to the elastic layer opposite a valve or pump in the fluidic structure; a fluidic robot configured to deliver or remove fluid from the aperture; a source of positive and/or negative pressure in communication with the actuation conduit; and a control unit comprising logic to operate the fluidic robot and to actuate the valve. In one embodiment the instrument comprises a plurality of fluidic circuits. In another embodiment the instrument further comprises a thermal regulator configured to regulate temperature in at least one non-microfluidic compartment. In another embodiment the instrument further comprises a source of magnetic force configured to transmit magnetic force to a compartment in the structure, e.g., a permanent magnet or an electromagnet.

In another aspect this invention provides a method comprising: moving a non-microfluidic volume of a liquid from a first non-microfluidic compartment into a microfluidic channel and from the microfluidic channel into a second non-microfluidic compartment, wherein the first microfluidic compartment, the microfluidic channel and the second microfluidic compartment are in fluid communication with each other in an article fabricated in one piece. In one embodiment the liquid is moved by at least one pumping valve.

In another aspect this invention provides a method comprising: providing a fluidic circuit comprising a plurality of non-microfluidic compartments in fluidic communication with a microfluidic channel in an article fabricated in one piece; moving a non-microfluidic volume of a liquid comprising an analyte from a first non-microfluidic compartment through the microfluidic channel and into another non-microfluidic compartment; moving a non-microfluidic volume of a liquid comprising a first reagent from one of the non-microfluidic compartments through the microfluidic channel and into the non-microfluidic compartment holding the analyte to form a first reaction mixture, reacting the first reagent with the analyte to form a first product; and moving a non-microfluidic volume comprising the first product from the non-microfluidic compartment through the microfluidic channel into another of the non-microfluidic compartments. In one embodiment the method further comprises: f) moving a non-microfluidic volume comprising the first product from the non-microfluidic compartment through the microfluidic channel into one of the non-microfluidic compartments; g) moving a non-microfluidic volume of a liquid comprising a second reagent from one of the non-microfluidic compartments through the microfluidic channel and into the non-microfluidic compartment comprising the first product; h) reacting the second reagent with the first product to form a second product; and i) moving a non-microfluidic volume comprising the second product from the non-microfluidic compartment through the microfluidic channel into another of the non-microfluidic compartments. In another embodiment the method further comprises: f) moving a non-microfluidic volume comprising the first product from the non-microfluidic compartment through the microfluidic channel into a chamber comprising magnetically responsive particles adapted to bind the first product and binding the first product to the particles; g) magnetically capturing the particles in the chamber; h) washing the particles; eluting the first product from the particles; and j) moving a non-microfluidic volume comprising the eluted first product through the microfluidic channel into another of the non-microfluidic compartments. In another embodiment the method of claim 15 further comprising regulating the temperature of the non-microfluidic compartment comprising the first reaction mixture. In another embodiment fluids are moved through the microfluidic channel with microfluidic diaphragm pumps.

In another aspect this invention provides a piece having a center of mass and comprising at least one microfluidic channel formed in a surface of the piece and at least one cavity in the surface defined by a wall, wherein the channel is in fluidic communication with the cavity, wherein a first draft angle defined by a first side of a wall of a cavity and an axis perpendicular to the surface is more oblique than a second draft angle defined by a second side of the wall of the cavity and the axis, wherein the first side is farther away from the center of mass than the second side.

In another aspect this invention provides a piece having a surface comprising a microfluidic channel and a relief, wherein the channel traverses the relief and a floor of the channel traversing the relief is inset deeper into the surface than a floor of the relief.

In another aspect this invention provides a piece having a surface, at least a portion of which is non-smooth, and at least one microfluidic channel formed in the non-smooth portion. In one embodiment the non-smooth surface comprises features selected from inverted and/or extraverted dimples, waves, scratches, waffles and ripples. In another embodiment substantially all of a surface adapted to mate with an elastic layer is non-smooth. In another embodiment the surface has an average arithmetic roughness between 1 micron and 10 microns.

### INCORPORATION BY REFERENCE

All publications and patent applications mentioned in this specification are herein incorporated by reference to the same extent as if each individual publication or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 shows a clamshell view of one embodiment of a diaphragm valve of this invention. A fluidics layer 101 comprises a fluid conduit comprising a fluidic channel 102 interrupted by a valve seat 103. In this embodiment, fluidic channel opens into a fluidics valve body 104. One face of the fluidics layer contacts the elastic layer 105 in the assembled device. This face comprises sealing surfaces 106, to which the elastic layer can be sealed, and exposed surfaces of the functional components—fluidic conduit including the valve seat. An actuation layer 111, comprises an actuation conduit comprising an actuation channel 112 and an actuation valve body disposed opposite the valve seat. The actuation layer also comprises a face that contacts the elastic layer in the assembled device that has sealing surfaces and exposed surfaces of functional elements.

FIG. 2 shows an assembled diaphragm valve in three dimensions. This valve is normally closed.

FIGS. 3A and 3B show a cross-section of a “three layer” diaphragm valve in closed (FIG. 3A) and open (FIG. 3B) configurations.

FIGS. 4A and 4B show a portion of a device in which the fluidics layer comprises a plurality of sublayers, in exploded and closed views. The top sublayer 121 is referred to as the “etch” layer and bottom sublayer 122 is referred to as the “via” layer. In this example the etch layer comprises grooves (e.g., 123 and 128) on the surface that faces the via layer to form a closed fluidic channel. The via layer comprises grooves (e.g., 124) on the surface that faces the elastic layer. When the elastic layer is bonded to or pressed against the via layer, it covers the channels and seals them against leakage. The via layer also includes vias (e.g., holes or bores) (e.g., 126 and 127) that traverse this sublayer and open onto the elastic layer on one side and the etch layer on the other. In this way, fluid traveling in a channel in the etch layer can flow into a conduit in the via layer that faces the elastic layer.

FIG. 5 shows a flow-through valve in which one channel 510 is always open and communication with another channel 520 is regulated by a valve. Flow-through channel 510 intersects with intersecting channel 520 at a junction where a flow-through valve 530 is positioned.

FIG. 6 shows a three-dimensional view of a device comprising three diaphragm valves in series forming a diaphragm pump.

FIG. 7 shows a three-dimensional view of a device comprising a fluidic structure fabricated in one piece comprising non-microfluidic compartments on one side of the structure communicating with microfluidic channels on another side of the structure. The structure of FIG. 7 has dimensions of about 90 mm×50 mm.

FIGS. 8A-8D depict different aspects of an article fabricated in one piece.

FIG. 9 shows a fluidic circuit diagram of one embodiment of this invention. The solid lines represent fluidic circuits and the dotted lines represent actuation circuits.

FIG. 10 shows a clamshell view of an embodiment of a normally open diaphragm valve of this invention. A fluidics layer 1001 comprises a fluid conduit comprising a fluidic channel 1002 interrupted by a valve seat 1003. The fluidic channel opens into a recessed dome 1015 that functions as a valve seat. When no pressure or negative pressure is exerted on elastic layer 1005, the elastic layer sits away from the valve seat, allowing for an open valve in which a fluid path between the channels entering the valve are in fluidic contact, creating a fluid path. When positive pressure is exerted on elastic layer 1005, the elastic layer deforms toward the valve seat to close the valve.

FIG. 11 shows a fluidic manifold side of a piece of this invention. Ports 1120, which can serve as reaction wells, are surrounded by a wall 1150 that defines a moat 1155. The moat can be filled with a liquid. Temperature regulator 1160 is removably insertable into the moat and can be configured to thermally regulate the temperature of the liquid in the moat which, in turn, regulates temperature of liquids in the ports.

FIG. 12 shows a view of a side (e.g., a “bottom side” or “microfluidic side”) of the article comprising microfluidic elements. Microfluidic channel 1206 is in fluid communication with aperture 1215, flow-through valve 1236, pumping valves 1226A and B and normally open valve 1216. Common waste channel, 1240, connects the circuits for waste removal though a common port.

FIG. 13 shows a portion of an actuation layer. The actuation layer comprises an actuation channel 1312 leading to a valve relief 1313. The actuation channel is configured so that as it transverses the valve relief, the floor of the actuation channel 1314 is set at a deeper level in the actuation layer than the floor of the valve relief. In this embodiment, the actuation channel forms a rail connecting a plurality of valve reliefs. Application of vacuum to the actuation channel pulls the elastic layer toward the floor of the valve relief. However, the inset of the actuation channel allows a path for transmission of pressure even when the elastic layer is in contact with the floor of the valve relief.

FIG. 14 shows features in a piece having features with asymmetric draft angles. Aperture 1420 forms a section of an oblique cone with axis shown by a dotted line. The draft of a first wall of the aperture that is further away from the mass center of the piece than a second wall of the aperture is configured with a more oblique angle alpha with respect to the axis than the angle beta formed by the draft of the second wall with respect to the axis.

FIG. 15 shows a mating surface of a workpiece of this invention. The work piece has microfluidic channel 1502 in fluidic communication with an aperture 1515 having a non-microfluidic volume. The sealing surface of the workpiece has a patterned, non-flat surface with features 1527 that have dimensions smaller than the fluidic features. The distance between two flat ideal surfaces within which the non-flat surface could be contained is greater than the distance between two flat ideal surfaces within which a non-pattered, e.g., smoother, surface could be contained. For example, the features can take the form of a sine wave having an amplitude between 3 microns and 30 microns, e.g., between 3 microns and 10 microns, e.g., about 5 microns.

### DETAILED DESCRIPTION OF THE INVENTION

1. Fluidic Structure Fabricated in One Piece

This invention provides an article fabricated in one piece that integrates microfluidic and non-microfluidic elements. In certain embodiments, the microfluidic and non-microfluidic elements together form a fluidic circuit. The article of this invention is fabricated in a single piece of material. That is, the elements it comprises are not assembled from separate pieces that are attached e.g., through clamping, bonding or gluing. These articles can be assembled with other articles into combination devices, e.g., MOVe devices, that are attached together. However, the article of this invention incorporates in one piece the elements recited.

A microfluidic channel has at least one cross-sectional dimension no greater than 500 microns, no greater than 400 microns, no greater than 300 microns or no greater than 250 microns, e.g., between 1 micron and 500 microns. A non-microfluidic volume as used herein refers to a volume of at least 5-microliters, at least 10 microliters, at least 100 microliters and least 250 microliters, at least 500 microliters, at least 1 milliliter or at least 10 milliliters. A macroscopic element has a dimension greater than 500 microns.

The article of this invention comprises a piece having an aperture that traverses the article and that defines a non-microfluidic volume. On at least one surface of the article onto which the aperture opens, the aperture is in fluidic communication with a microfluidic channel imposed on the surface or disposed internally thereto. By traversing the piece the aperture forms a conduit communicating between the two surfaces of the article onto which it opens. The conduit forms, for example, a bore. Such a conduit can function as an outlet passage from the piece. A non-microfluidic aperture that is in fluid communication with a microfluidic channel on a first surface generally will have a smaller port on that surface than on the other surface onto which it opens. Thus, the aperture can take the shape of a well or compartment, or can function as an exit port. The apertures can be adapted to receive a liquid and transmit it to the microfluidic channel with which they are in fluid communication. The compartments can take any desired shape such as cylindrical, cone shaped, box shaped, etc. The microfluidic channel can be in communication with a variety of elements, such as openings, conduits, chambers and valve chambers and seats. (For purposes of this invention, conduits are considered to be in fluid communication even if it is across a valve seat, unless otherwise indicated.)

In certain embodiments, the articles of this invention are substantially chip or plate shaped, having two substantially opposing sides, in which one side has microfluidic elements and the other side has macrofluidic or macroscopic (i.e., having a dimension greater than 500 microns) elements. Typically, a macrofluidic element, e.g., a chamber or well, on one side is in fluidic communication through the article with a microfluidic element, e.g. a channel, on the other side.

Fluidic conduits can be comprised in a plurality of fluidic circuits. This allows parallel processing of samples or multiplexing. The number of circuits that a piece can have can be a multiple of 8 or 12, e.g., 8, 12, 16, 24, 32, 36, 40, 48 or 96. In certain embodiments, the piece comprises non-microfluidic wells on a first side of the piece that open onto a second side of the piece and fluidically communicate there with microfluidic channels in the second side.

Microfluidic elements are not limited to one surface onto which the aperture opens. A second surface also can comprise microfluidic elements, such as microfluidic channels. These elements can be in communication with apertures, non-microfluidic or microfluidic, that traverse the article. Accordingly, in certain embodiments, an aperture fluidically connects microfluidic channels on different sides of the article. The monolithic fluidic piece typically comprises a first surface that comprises a plurality of conduits. The conduits can comprise channels (e.g., trenches), valve seats, compartments and other elements formed in the first surface. The conduits can connect to the apertures or holes.

In certain embodiments, a side of the piece comprising microfluidic elements does not comprise macro fluidic or macroscopic elements.

Similarly, a surface that comprises a microfluidic channel in communication with an aperture also can comprise non-micro fluidic elements, such as non-micro fluidic chambers, which can be in fluid communication with microfluidic channels therein.

The article can take a plate-like or chip-like shape, e.g., having two sides oriented substantially parallel with or opposite one another. The aperture can form a compartment, e.g., a well, in one surface of the article, e.g., adapted to receive and hold a non-microfluidic volume of a liquid. The compartment communicates through a hole in an opposing side of the article. The opposing side comprises microfluidic elements, such as channels, that communicate with the well through the hole.

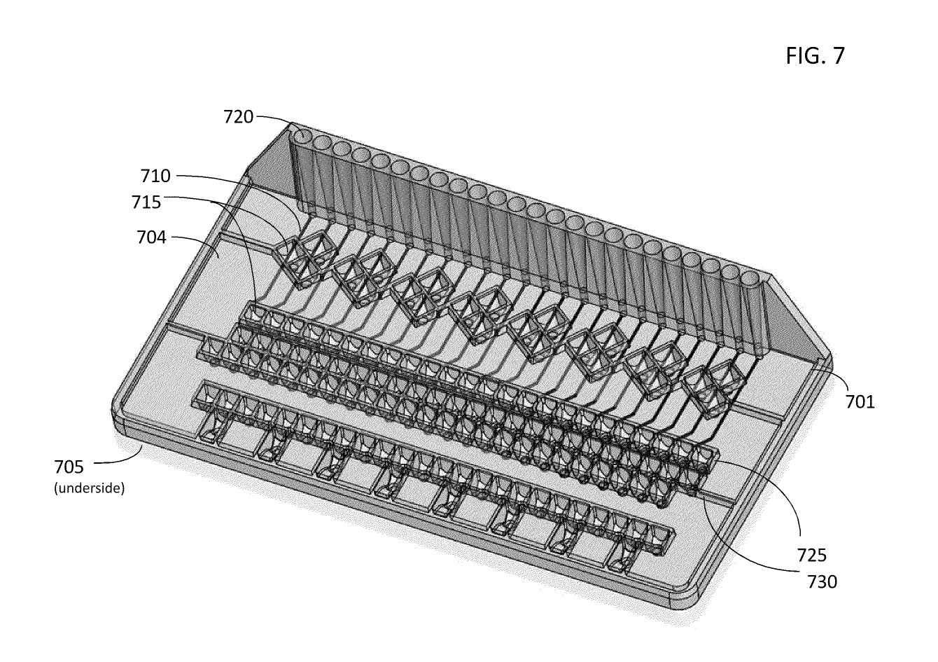

In another embodiment, the monolithic piece comprises reaction wells configured to receive magnetically responsive particles and having an external surface configured to engage with a heating element and/or a source of magnetic field that can hold the particles in place. For example, the piece could have a fold that is oriented, for example, at about 90 degrees with respect to the fluidic surface. The fold can comprise the wells disposed in an edge of the fold and communicating with microfluidic channels in the fluidic surface. (See, for example, FIG. 7.) For example, the section can have a substantially flat side that engages a Peltier device or other thermocouple.

The monolithic piece of this invention is useful, among other things, as a combined fluidic manifold and microfluidic layer in a three-part fluidic device formed as a sandwich, referred to as a “MOVe” device. MOVe devices comprise a fluidic part, an actuation part and an elastic layer sandwiched between them. As described in more detail below, microfluidic elements, such as diaphragm valves and pumps, are formed from the combination of these parts in which conduits in the actuation part actuate movement in the elastic layer which regulate movement of fluids in the fluidic piece. The diaphragm valves are actuated by an actuation channel in the actuation layer wherein applying positive or negative pressure on the elastic layer through the actuation channel actuates the valves. (That is, positive or negative pressure relative to the pressure on the other side of the elastic layer.)

Accordingly, the surface of the side comprising a microfluidic channel can be configured so that when overlaid with a layer of an elastic material, such as PDMS, the layer covers the channels, thereby closing them on one side, and forms a good seal with the contacting surface of the first side that inhibits leakage of liquid flowing through the channels. By including a plurality of non-microfluidic compartments that connect with each other through a microfluidic channel, devices of this invention can route non-microfluidic volumes between numerous chambers to allow for mixing of different fluid volumes, e.g., samples and reagents, holding volumes between reactions and outputting products into non-microfluidic compartments for removal from the device.

The fluidic part, elastic layer and actuation part work together effectively when a seal can be formed between the elastic layer and a surface of a monolithic piece comprising microfluidic channels, and with the actuation surfaces. Such a seal generally requires physical conformity between the surfaces of the three parts. Certain elastic materials, such as PDMS, have sufficient thickness that, when sandwiched between the faces, can tolerate differences in distance between parts of these two layers. However, pressure on the elastic layer may cause it to buckle or squeeze. Accordingly, the pieces can be provided with tolerances to accommodate these deformations.

Accordingly, the sealing surfaces (e.g., the portions of the first surface intended to contact the elastic layer, e.g., other than the indentations or recesses forming microfluidic conduits) can be substantially planar. A substantially planar surface can be, for example, a surface having the flatness of float glass. In this case, the elastic layer covers microfluidic conduits and actuation conduits to form closed conduits, and seals against the sealing surfaces to prevent leakage of liquids or actuation fluids from the conduits.

When formed from a heated polymer, such pieces can warp when they cool. In this case, a surface that is meant to be substantially planar (e.g., flat) can take a non-planar conformation, for example by introducing sink marks or by curving. Such surfaces may not mate well with an elastic layer and/or with an actuation piece having a surface that is, itself, substantially planar or at least, non-conforming to the fluidic piece. However, by pressing the fluidic piece against a hot planar surface, such as hot glass, the plastic can be shaped so that it comprises a substantially planar sealing surface for the elastic layer and for the actuation surface of the actuation piece.

The monolithic fluidic piece can have substantial three dimensional features or aspects, particularly in portions or sides other than those with surfaces to be mated with fluidics machinery. These features include, for example, non-microfluidic compartments; uneven, non-flat or non-planar surfaces; elevations on a side that are tall compared with other surfaces on that side; or bends or dimensions that render the piece block-like rather than chip-like, e.g., having no dimension of which is significantly smaller than the other two dimensions of the piece.

In another aspect, the sealing surfaces can be non-flat, e.g., rough. Roughness can be created by intentionally providing features on the surface that deviate from a mean. Such features can be referred to as relief areas. The features can take a variety of shapes, for example, introverted or extraverted dimples, relief wells, waves, ripples, walls, sawtooths, etc. The surface can be patterned with features. The ratio of the piece length to deviation height can be, for example, between about 10:000 to 1 and about 1000 to 1. Features can deviate from an ideal planar surface of the piece by, for example, less than about 1 mm, less than about 100 microns or less than about 10 microns. They typically will deviate by at least 3 microns. The surface can have an average arithmetic roughness of, for example, between about 1 micron and about 10 microns. Typically, the features have dimensions less than those of the microfluidic features on the article, e.g., a log₁₀ or more smaller. Surfaces of the fluidic piece and all of the actuation piece that face the elastic layer can be provided with one or more relief areas. Relief areas can be, for example, indentations having, for example, circular shapes. Relief areas can be positioned near functional features so that contact surfaces of the piece near the functional features provide greater pressure or a better seal against the elastic layer. Relief areas allow the elastic layer, which is under deforming pressure from the fluidic layer in the actuation layer, room to deform without warping. The elastic layer will tend to deform into the relatively larger reliefs rather than the fluidic or actuation features.

Alternatively, the mating surfaces can take any desired shape, as long as the elastic layer can conform to and seal the fluidic surface, creating closed channels, valve chambers and other features, and the actuation surface can conform to and seal with the mated elastic surface. For example, the surface could be curved, e.g., having substantially the contour of a section of a cylinder or a sphere.

When assembled as part of a MOVe device, e.g., comprising a fluidic piece, actuation piece and elastic layer sandwiched between them, the device can be configured as a cartridge. The cartridge can be configured to engage an instrument such that actuation ports in the actuation piece communicate with sources of positive or negative pressure to actuate the elastic layer. It also can engage an instrument so as to be positioned to be accessible to a fluid robot that delivers or removes fluids from fluidic compartments on the device.

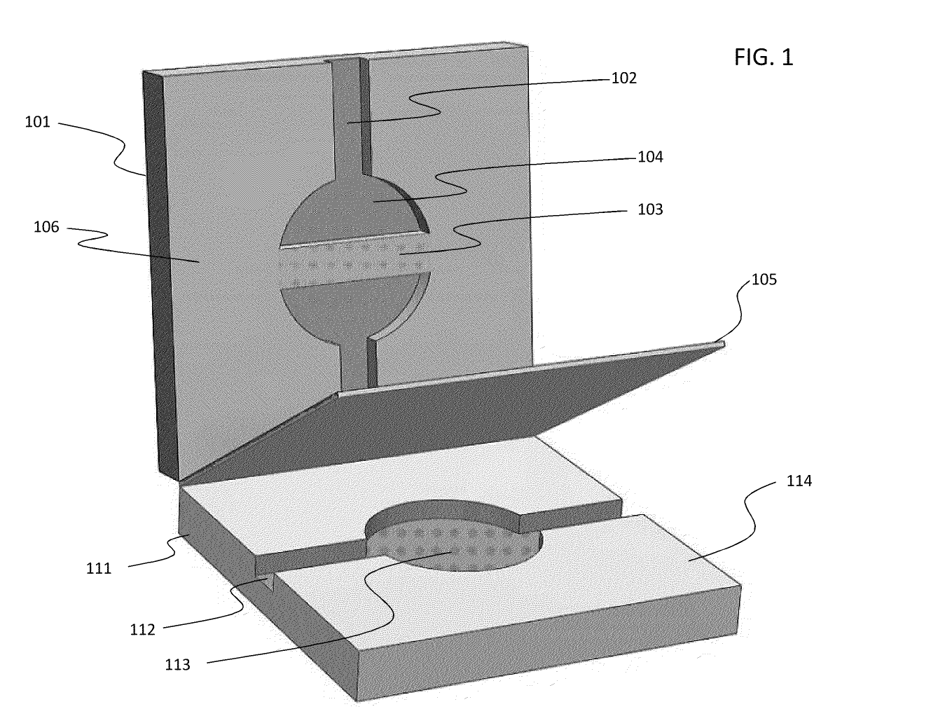

One embodiment of the monolithic piece is depicted in FIG. 7. FIG. 7 presents a view of a monolithic fluidic piece 701. The piece can be combined with an elastic layer and an actuation layer to form a MOVe device, for example as shown in FIG. 1. The piece shown here is generally rectangular in shape. A fluidics side 705 opposes a port side 704. The two sides have surfaces which are generally parallel with each other. The structure shown comprises 24 fluidic circuits. Each circuit comprises a microfluidic channel 710. The circuits also comprise a plurality of non-microfluidic compartments on the port side configured as open wells 715. The wells also comprise a retaining wall 725 that protrudes from the flat surface of the piece and provides more volume for the well. This embodiment also comprises in a circuit a non-microfluidic reaction compartment 720. This reaction compartment is disposed in a wall of compartments. The wall has a substantially flat face that is configured to access heat from a thermal regulatory element or magnetic flux from a magnet. The piece also comprises extruding ribs 730 in the body and around the edge that provide rigidity to the structure.

The device of FIG. 7 has twenty-four circuits. The wells of the device of FIG. 7 are arrayed in a fashion compatible with 96-well technologies. Fluid handling robots typically have 8 or 12 probes. This matches the number of rows or columns in a standard 96-well plate. These probes typically have a pitch of 9 mm. Accordingly, the device of FIG. 7 has three sets of eight wells, each well in a set spaced about 9 mm from an adjacent well in the set. The three sets are interspersed so that a set of three wells, one from each set, is confined to 9 mm. In this way, samples from each of 96 wells in a 96-well plate can be loaded into sample wells of four devices. Furthermore, the wells in this embodiment are tapered, narrowing toward the elastic layer. This tapered shape assists in guiding the probes through the piece and toward the surface of the elastic layer. However, the piece can take any shape useful to the user. One surface functions as the fluidics surface and comprises microfluidic components including microfluidic channels and valve structures. The fluidics surface also comprises non-microfluidic chambers for carrying out reactions or storing liquids.

An article comprising non-microfluidic wells communicating with microfluidic channels in three-layer devices can be used with a fluid handling robot. The robot typically delivers liquids through pins to sample wells. By providing wells with walls that connect with an elastic layer, the pin, as it is lowered, is directed to the surface of the elastic layer. There, it can deliver liquid to the well without an air bubble between the elastic layer and the delivered liquid.

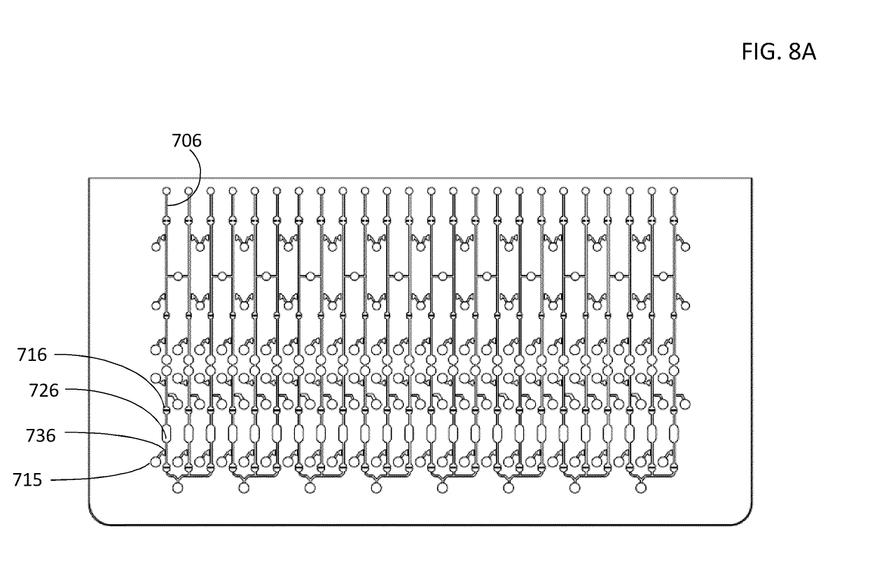

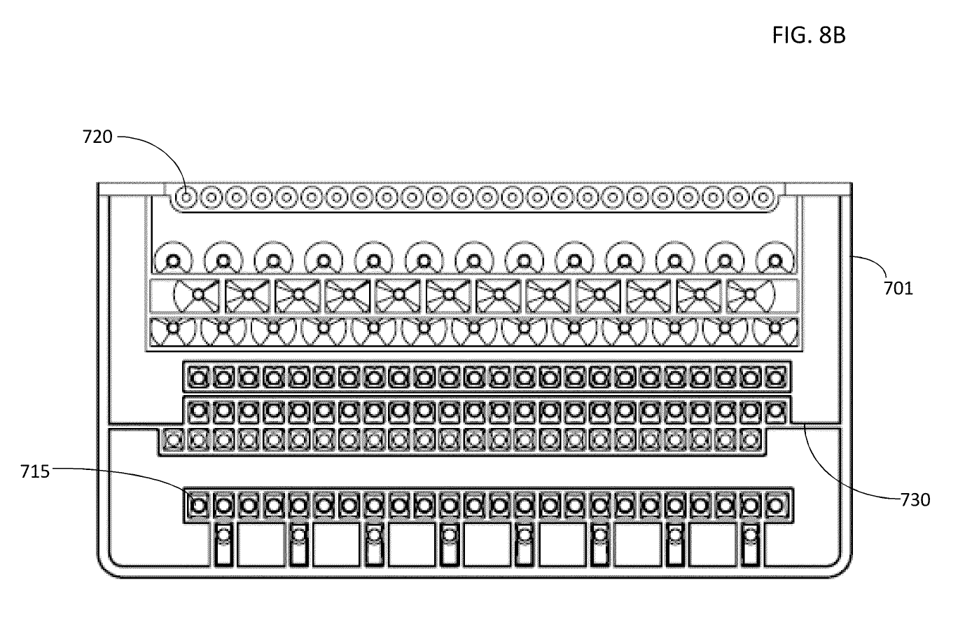

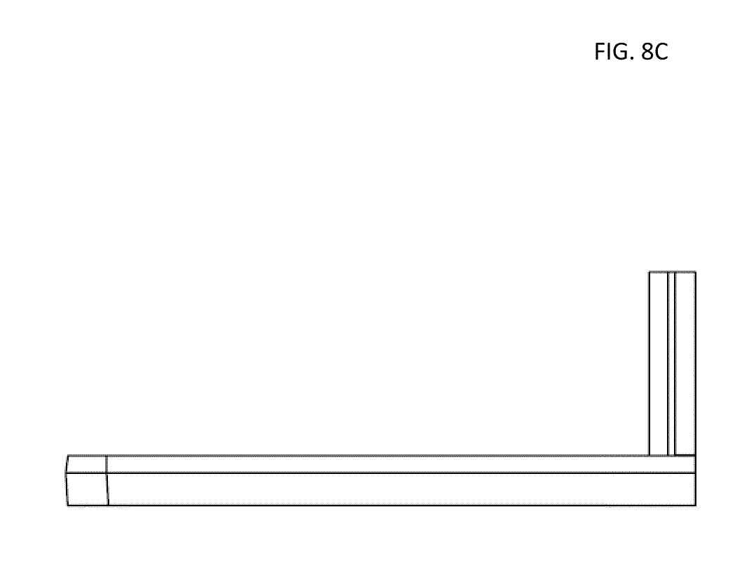

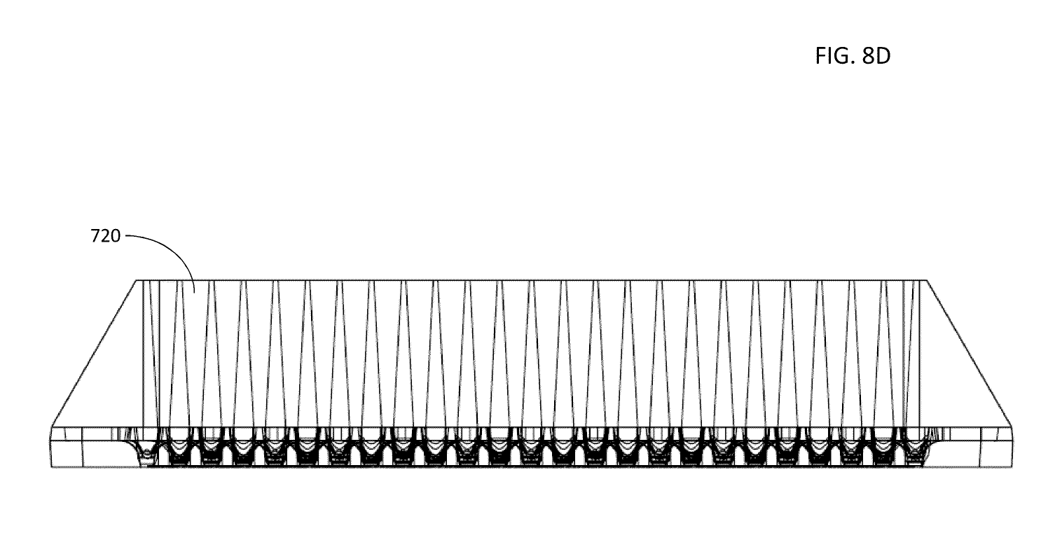

FIG. 8A-8D show different perspectives of a fluidic article fabricated in one piece. FIG. 8A shows a view of a first side (e.g., a “bottom side”) of the article comprising microfluidic elements. Microfluidic channel 706 is in fluid communication with aperture 715, flow-through valve 736, pumping valve 726 and seated valve 716. FIG. 8B shows an opposite side (e.g., a “top side”) of a monolithic piece configured for loading samples and reagents, and comprising reaction wells 720 that are substantially perpendicular to the bottom surface. FIG. 8C depicts a side view of the article that shows a wall comprising reaction wells. FIG. 8D depicts a back view of the wall of the article and showing reaction wells 720.

The monolithic fluidic piece can be made of any material that can take the proper form. This includes, for example, plastic, glass, silicon, etc. In certain embodiments, the piece is comprised of plastic, e.g., molded plastic, e.g., injection molded plastic.

2. Articles and Devices

The fluidic devices of this invention comprise at least one or a plurality of fluidic conduits in which fluid flows. Fluid can be introduced into or removed from the device through ports communicating with fluidic conduits (e.g. entry ports or exit ports). Flow can be controlled by on-device diaphragm valves and/or pumps actuatable by, for example, pressure (e.g., pneumatic, hydraulic or mechanical). The devices typically comprise a fluidics layer bonded to an elastic layer, wherein the elastic layer functions as a deflectable diaphragm that regulates flow of fluids across in the fluidic pathways in the fluidics layer. The elastic layer can comprise a polysiloxane, such as PDMS.

In other embodiments, the device comprises three layers: A fluidics layer, an actuation layer and an elastic layer sandwiched there-between. The actuation layer can comprise actuation conduits configured to actuate or deflect the elastic layer at selected locations, e.g., at diaphragm valves, thereby controlling the flow of fluid in the fluidic conduits. Actuation conduits can be disposed as apertures, e.g., bores, through the layer, or as channels cut into the surface of the layer and opening at an edge of the piece. The three layers can be bonded together into a unit. Alternatively, the fluidics layer or the actuation layer can be bonded to the elastic layer to form a unit and the unit can be mated with and/or removed from the other layer. Mating can be accomplished, for example, by applying and releasing pressure, e.g., by clamping. The face of the microfluidic device that contacts the elastic layer can have an area from about 1 cm² to about 400 cm².

The face of a fluidics layer or an actuation layer that faces the elastic layer in a sandwich format is referred to as a mating face. A mating face typically will have functional elements such as conduits, valves and chambers that are exposed to and are covered by the elastic layer. The surfaces of such functional elements are referred to as functional surfaces. When mated together and assembled into a sandwich, the portions of the mating faces that touch the elastic layer are referred to as sealing surfaces. Sealing surfaces may be bonded to or pressed against the elastic layer to seal the device against leaks. Portions of the surfaces that face the elastic layer that do not normally contact the elastic layer are referred to as exposed surfaces. Surfaces over which fluid flows, including conduits, channels, valve or pump bodies, valve seats, reservoirs, and the like are referred to as functional surfaces.

Fluidic conduits and actuation conduits may be formed in the surface of the fluidic or actuation layer as furrows, dimples, cups, open channels, grooves, trenches, indentations, impressions and the like. Alternatively, they can be formed within a piece, e.g., as a closed channel. Conduits or passages can take any shape appropriate to their function. This includes, for example, channels having, hemi-circular, circular, rectangular, oblong or polygonal cross-sections. Valves, reservoirs and chambers can be made having dimensions that are larger than channels to which they are connected. Chambers can have walls assuming circular or other shapes. Areas in which a conduit becomes deeper or less deep than a connecting passage can be included. The conduits comprise surfaces or walls that contact fluids flowing through them. The fluid in the fluidic layer can be a liquid or a gas. In the case of an actuation layer, the fluid is referred to as an actuant. It can be a gas or a liquid.

In the construction of the fluidic device, contact of the elastic layer to all or part of the contact surfaces, e.g., by pressure or bonding, can cover exposed conduits and contain liquid within the fluid or actuation conduits. In the functioning of valves and pumps, a diaphragm moves on or off a valve seat or contact surface and toward or away from the surface of a body chamber in the fluidics or actuation layer. If the elastic layer sticks to a valve seat, contact surface, or to any exposed functional surface of the device, the device may not function properly. The devices can be configured to decrease sticking between the elastic layer and functional elements of the device, such as fluidic or actuation conduits, valve seats, valve bodies or chambers and channels. In particular, surfaces of the fluidics and/or actuation layers that are likely to contact the elastic layer during operation of the device can be addressed to inhibit sticking or bonding. This includes valve seats in the fluidics layer and valve bodies in the actuation layer.

The fluidics layer, itself, can be comprised of more than one sublayer, wherein channels in certain sublayers connect through vias in other sublayers to communicate with other channels or with the elastic layer. In multiple sublayer configurations, fluidic paths can cross over one another without being fluidically connected at the point of crossover. In certain embodiments, a fluidic layer can comprise alternating layers of plastic bonded to an elastic material bonded to a plastic, etc. In such configurations, vias can traverse through both plastic and elastic materials to connect with other layers.

In an embodiment of an article in one piece of this invention, a fluidic conduit on one side the piece can communicate through a channel in the piece to another side that comprises fluidic conduits. These conduits can be overlaid with a material to seal the conduits.

Diaphragm valves and pumps are comprised of functional elements in the three layers. A diaphragm valve comprises a body, a seat, a diaphragm and ports configured to allow fluid to flow into and out of the valve. The body is comprised of a cavity or chamber in the actuation layer that opens onto the surface facing the elastic layer (“actuation valve body”). Optionally, the valve body also includes a chamber in the fluidics layer that opens onto a surface facing the elastic layer and which is disposed opposite the actuation layer chamber (“fluidics valve body”). The actuation layer body communicates with a passage, e.g., a channel, through which positive or negative pressure can be transmitted by the actuant. When the actuant is a gas, e.g., air, the actuation layer functions as a pneumatics layer. In other embodiments, the actuant is a liquid, such as water, oil, Fluorinert etc.

A valve inlet and a valve outlet communicate with fluidic conduits in the fluidics layer to form a fluidic path. A valve inlet and a valve outlet comprise openings on the surface of the fluidics layer facing the elastic layer. The portion of the surface of the fluidics layer between the valve inlet in the valve outlet can function as a valve seat. The elastic layer provides one or more diaphragms. A diaphragm in a valve is actuatable to be positioned against or away from a valve seat, closing or opening the valve. An actuator to actuate the diaphragms is comprised, at least in part, in the actuation layer.

In this configuration, the position of the diaphragm alters the effective cross-section of the fluidic conduit and, thus, can regulate the speed of flow through the valve. In such a configuration, the valve may not completely block the flow of fluid in the conduit. This type of valve is useful as a fluid reservoir and as a pumping chamber and can be referred to as a “pumping valve”.

The valve may be configured so that the diaphragm naturally sits on the valve seat, thus closing the valve, when no differential pressure is applied, and is deformed away from the seat to open the valve (a so-called “normally closed” valve). The valve also may be configured so that when no differential pressure is applied, the diaphragm naturally does not sit on the seat and is deformed toward the seat to close the valve (a so-called “normally open” valve). In this case, application of positive pressure to the elastic layer from the actuation conduit will push the elastic layer onto the valve seat, closing the valve. Thus, the diaphragm is in operative proximity to the valve seat and configured to be actuatable to contact the valve seat or to be out of contact with the valve seat.

In an embodiment of a valve seat for a normally closed valve, fluidic conduits can comprise interruptions, that is, material that partially or completely blocks fluid flow in a conduit. When negative relative pressure is applied to the diaphragm, it moves off the valve seat, creating a fluidic chamber or passage through which fluid may flow.

The ports into a valve can take a variety of configurations. In certain embodiments, the fluidic channels are comprised on the surface of the fluidics layer that faces the elastic layer. A valve can be formed where an interruption interrupts the channel. In this case, the port comprises that portion of the channel that meets the interruption and that will open into the valve chamber when the diaphragm is deflected. In another embodiment, a fluidic channel travels within a fluidics layer. In this case, ports are formed where two vias made in the fluidics layer communicate between two channels and the elastic layer across from an actuation valve body. (The two adjacent vias are separated by an interruption that can function as a valve seat.) In another embodiment, a fluidic channel is formed as a bore that traverses from one surface of the fluidic layer to the opposite surface which faces the elastic layer. A pair of such bores separated by an interruption can function as a valve. When the elastic layer is deformed away from the interruption (to which it is not bonded), a passage is created that allows the bores to communicate and for fluid to travel in one bore, through the valve and out the other bore.

Microfluidic devices with diaphragm valves that control fluid flow have been described in U.S. Pat. Nos. 7,445,926 (Mathies et al.), 7,745,207 (Jovanovich et al.), 7,766,033 (Mathies et al.), and 7,799,553 (Mathies et al.); U.S. Patent Publication Nos. 2007/0248958 (Jovanovich et al.), 2009-0253181 (Vangbo et al.), 2010/0165784 (Jovanovich et al.), 2010/0285975 (Mathies et al.) and 2010-0303687 (Blaga et al.); PCT Publication Nos. WO 2008/115626 (Jovanovich et al.) and WO 2010/141921 (Vangbo et al.); PCT application PCT/US2010/40490 (Stern et al., filed Jun. 29, 2010); U.S. application Ser. No. 12/949,623 (Kobrin et al, filed Nov. 18, 2010); and U.S. provisional applications 61/330,154 (Eberhart et al., filed Apr. 30, 2010), 61/349,680 (Majlof et al., filed May 28, 2010) 61/375,758 (Jovanovich et al., filed Aug. 20, 2010) and 61/375,791 (Vangbo, filed Aug. 20, 2010).

MOVe (Microfluidic On-chip Valve) elements, such as valves, routers and mixers are formed from sub-elements in the fluidics, elastic and actuation layers of the device. A MOVe valve is a diaphragm valve formed from interacting elements in the fluidics, elastic and actuation layers of a microfluidic chip (FIG. 1). The diaphragm valve is formed where a microfluidic channel and an actuation channel cross over each other and open onto the elastic layer. At this location, deflection of the elastic layer into the space of the fluidics channel or into the space of the pneumatics channel will alter the space of the fluidics channel and regulate the flow of fluid in the fluidics channel. The fluidics channel and actuation channels at the points of intersection can assume different shapes. For example, the fluidics channel can comprise an interruption that functions as a valve seat for the elastic layer. The fluidics channel could open into a chamber like space in the valve. The actuation channel can assume a larger space and/or cross-section than the channel in other parts of the actuation layer, for example a circular chamber.

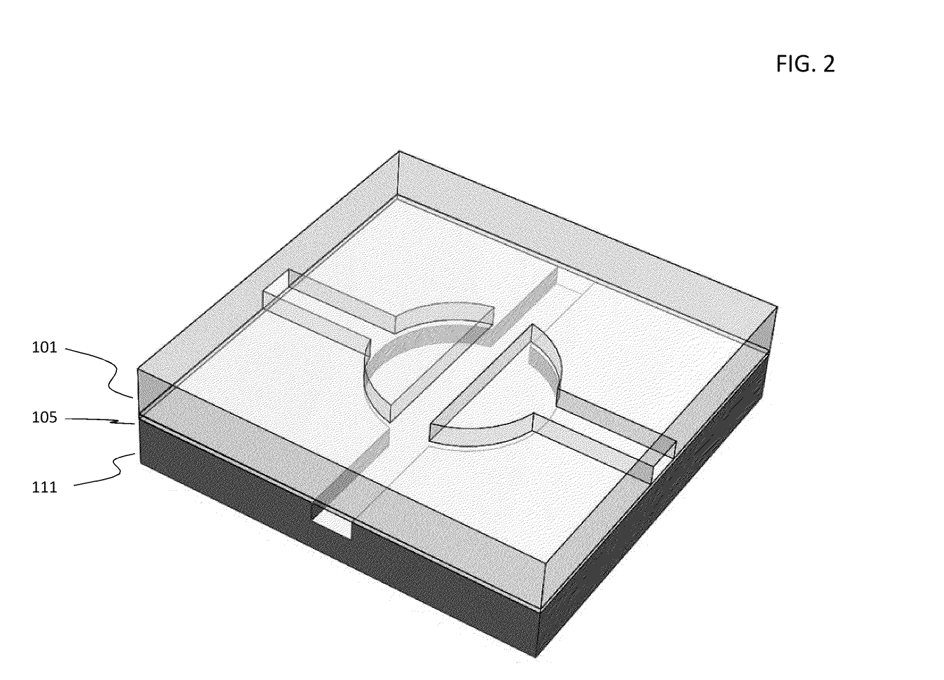

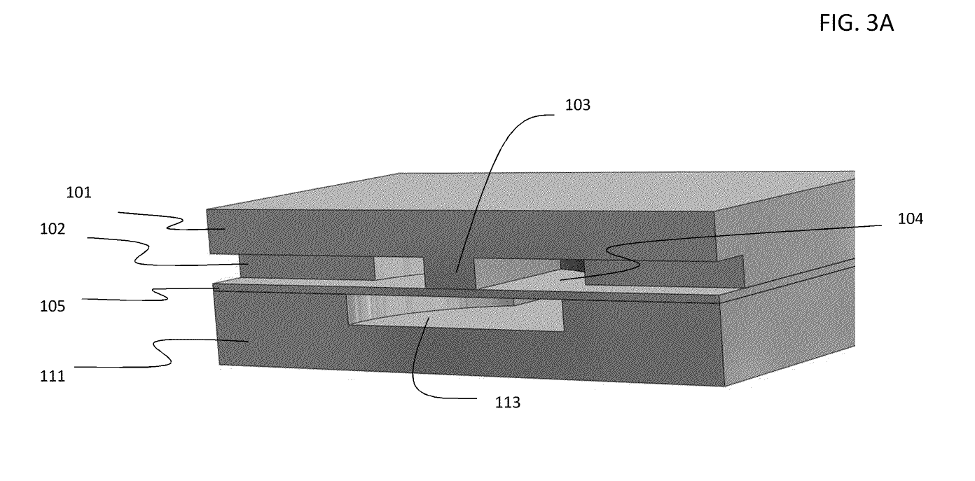

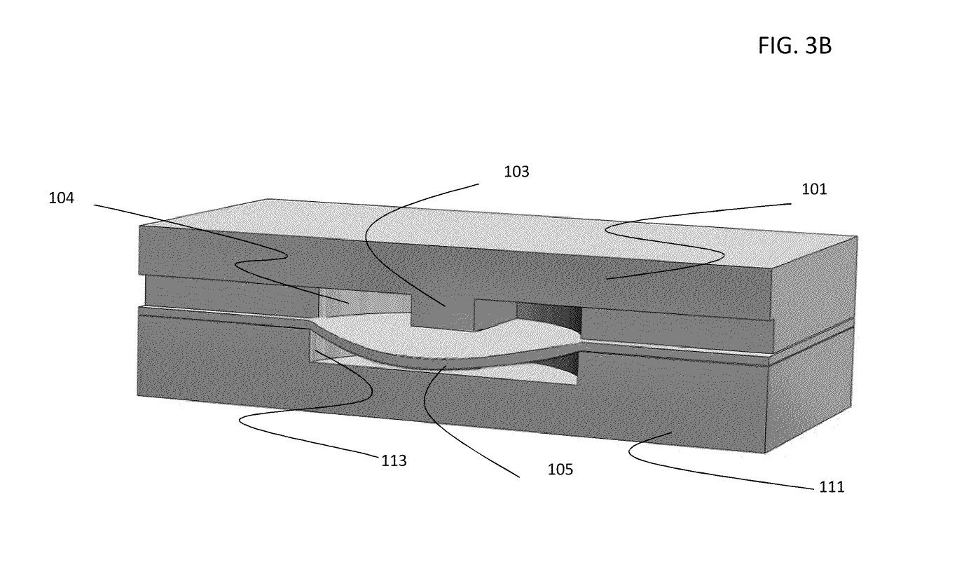

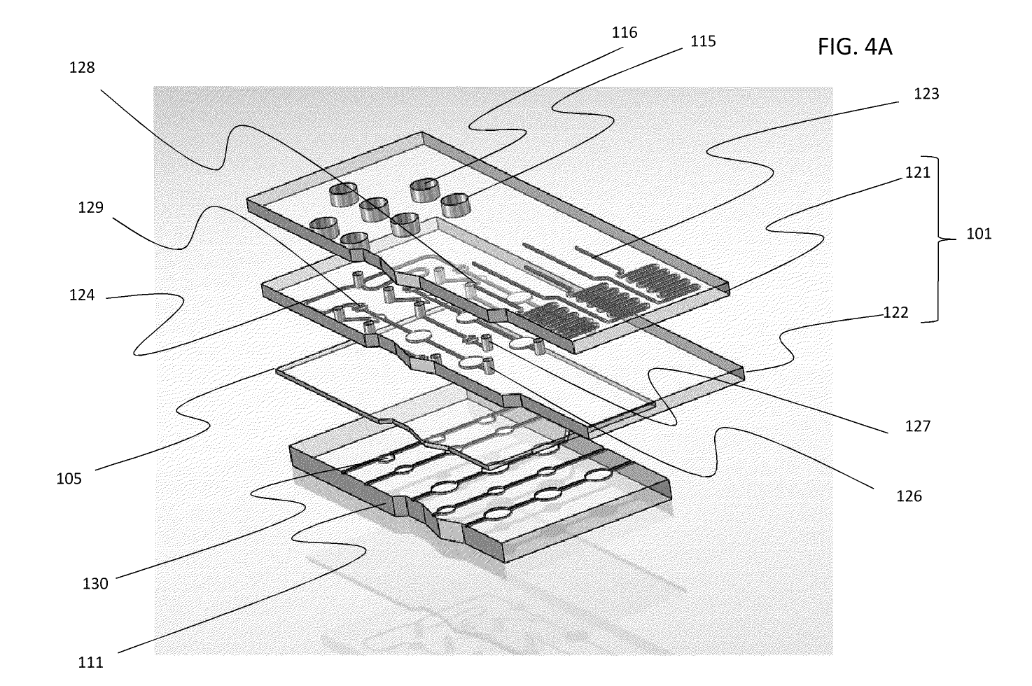

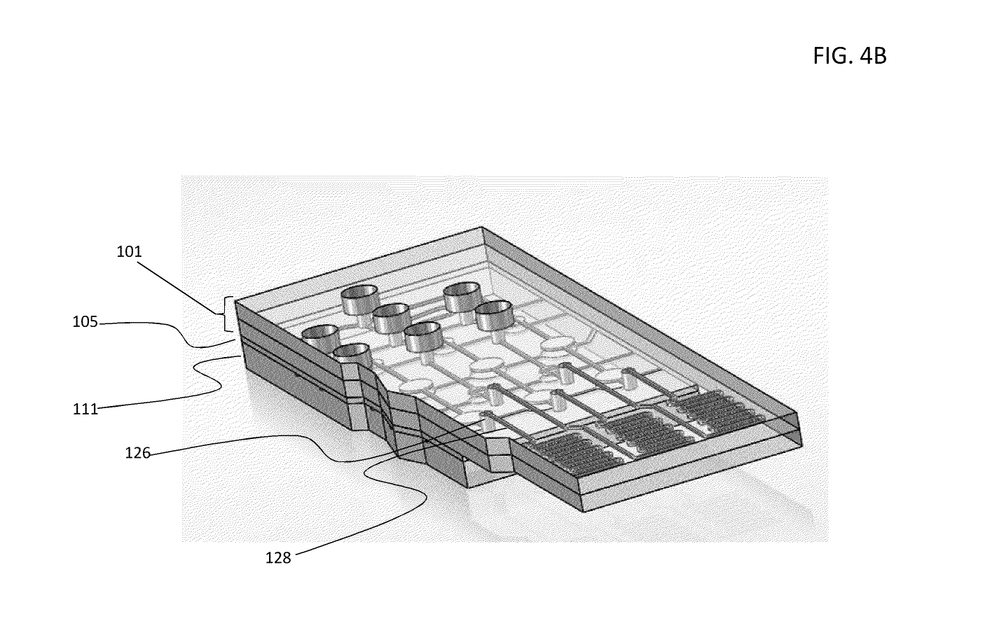

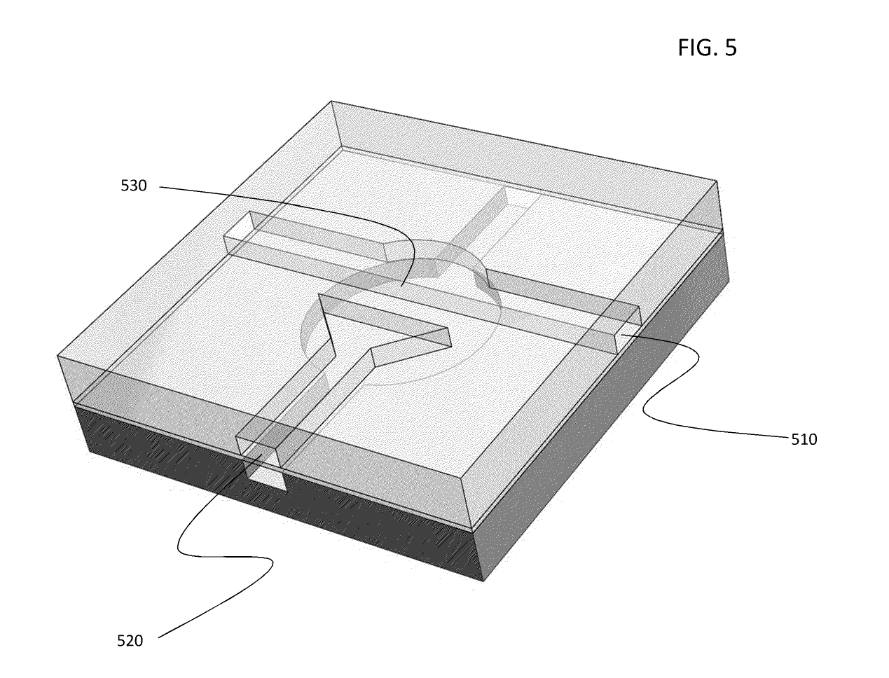

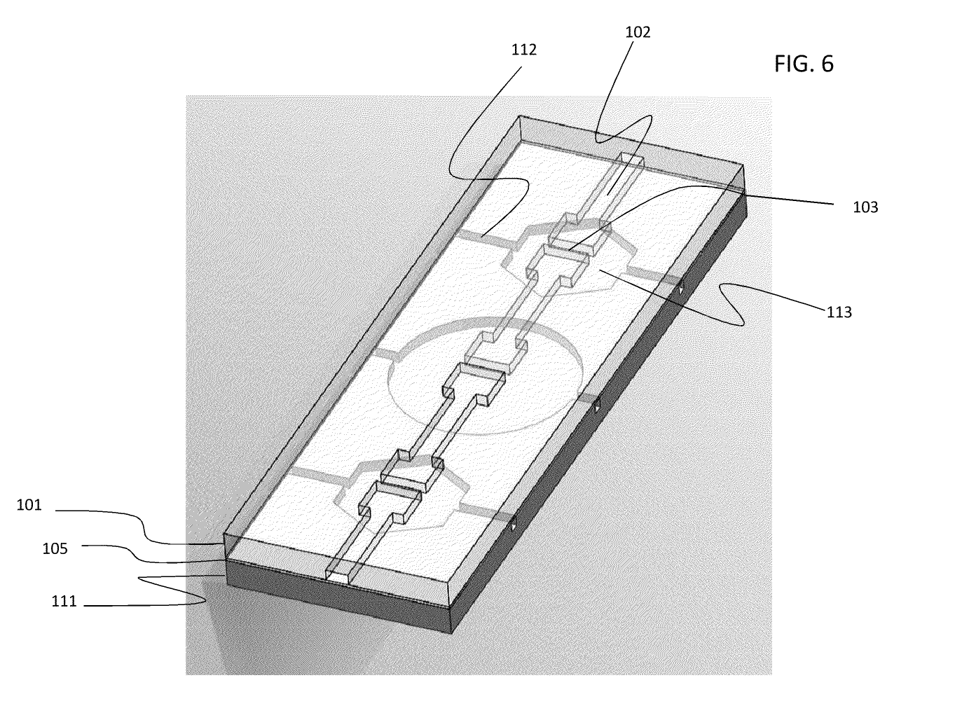

In one embodiment, the valve seat is configured as an interruption in a fluidic channel disposed along the mating face of a fluidics layer. In this case, the channels are covered over by the elastic layer. The termini of the channels that are coincident with the valve recess function as valve inlet and valve outlet. FIG. 2 shows a three-dimensional view of a diaphragm valve. FIGS. 3A and 3B show a diaphragm valve in cross-section. In this case, the fluidics layer comprises channels that are formed in the surface of the fluidics layer and covered over by the elastic layer. FIG. 4 shows a flow-through valve comprising one channel that is always open and a channel that intersects in which fluid flow into the open channel is regulated by a diaphragm valve. Opening the valve allows fluid to flow to or from the intersecting channel and flow-through channel. FIG. 5 shows a three-dimensional view of a diaphragm pump formed from three diaphragm valves in series.

Referring to FIGS. 4A and 4B, fluidics layer 101, elastic layer 105 and actuation layer 111 are sandwiched together. Microfluidic channel 128 opens onto the elastic layer through a via 126. Valve seat 129 is in contact with the elastic layer, resulting in a closed valve. When the actuation layer is activated, the elastic layer 105 is deformed into the pneumatic chamber 130. This opens the valve, creating a path through which liquid can flow. The pressure in the pneumatic chamber relative to the microfluidic channel controls the position of the elastic layer. The elastic layer can be deformed toward the pneumatic chamber when the pressure is lower in the pneumatic chamber relative to the microfluidic channel. Alternatively, the elastic layer can be deformed toward the microfluidic channel when the pressure is lower in the microfluidic channel relative to the pneumatic chamber. When pressure is equal or approximately equal in the microfluidic channel and the pneumatic chamber, the valve can be in a closed position. This configuration can allow for complete contact between the seat and the elastic layer when the valve is closed. Alternatively, when pressure is equal or approximately equal in the microfluidic channel and the pneumatic chamber, the valve can be in an open position. The pneumatically actuated valves can be actuated using an inlet line that is under vacuum or under positive pressure. The vacuum can be approximately house vacuum or lower pressure than house vacuum, e.g., at least 15 inches Hg or at least 20 inches Hg. The positive pressure can be about 0, about 1, about 2, about 5, about 10, about 15, about 20, about 25, about 30, about 35, more than 35 psi or up to about 150 psi. The fluid for communicating pressure or vacuum from a source can be any fluid, such as a liquid or a gas. The gas can be air, nitrogen, or oxygen. The liquid can be any pneumatic or hydraulic fluid, including organic liquid or aqueous liquid, e.g., water, a per fluorinated liquid (e.g., Fluorinert), dioctyl sebacate (DOS) oil, monoplex DOS oil, silicon oil, hydraulic fluid oil or automobile transmission fluid.

Alternatively, the valve can be normally open. In this case, application of positive pressure to the elastic layer from the actuation conduit will push the elastic layer onto the valve seat, closing the valve. This embodiment can be made by, for example, making the surface of the valve seat recessed with respect to the surface of the fluidic layer bonded to the elastic layer. In this case, the valve seat will be raised with respect to the elastic layer. Positive pressure on the elastic layer pushes the elastic layer against the valve seat, closing the valve.

In another embodiment of a normally open valve, the valve seat is not configured as an interruption in a fluidic conduit. Rather, it takes the form of a recess with respect to surface of the fluidics layer that normally contacts the elastic layer, so that the elastic layer does not sit against the recessed surface without application of pressure on the elastic layer, e.g. through the actuation chamber. In this case, the valve may not have a discrete valve chamber in the fluidics layer that is separate from the valve seat. The valve seat can take a curved shape that is concave with respect to the surface of the fluidic layer, against which the elastic layer can conform. For example, the valve shape can be an inverted dimple or a dome. Its shape can substantially conform to the shape of the elastic layer when deformed by pressure. It can take the shape substantially of a parabola or a sphere. Such a configuration decreases the dead volume of the valve, e.g., by not including a valve chamber that contains liquid while the valve is closed. This valve also comprises a surface against which the elastic layer can conform easily to close the valve. Also, this configuration eliminates the need to create a surface patterned so that valves do not comprise surface hydroxyl groups, because the recessed surfaces do not bond with the elastic layer against which they are laid during construction. In another embodiment, the concave surface can comprise within it a sub-section having a convex surface, e.g., an inverted dimple comprising an extraverted dimple within it forming, for example, a saddle shape. The convex area rises up to meet the elastic layer under pressure, creating a better seal for the valve. The saddle-shaped valve can operate to change the flow resistance in a conduit: As differential pressure increases, first the extraversion and then the inversion are covered by the elastic layer, changing the volume of the flow path.

In certain embodiments of a normally open valve, the concavity is recessed less than the channels to which it is connected. For example, the deepest part of the concavity can be about one-third to one-half the depth of the channel (e.g., 30 microns to 50 microns for the concavity versus 100 microns for the channel). For example, the elastic layer may be about 250 microns, the channels about 100 microns deep and the valve seat about 30 microns deep. The thinner the elastic layer, the deeper that the concavity can be, because the elastic layer can conform to the concavity without excessive deformation. In certain embodiments the channels can enter partially into the concavity, for example forming a vault. In certain embodiments, the channels and concavity are formed by micromachining. The actuation layer can comprise a valve relief into which the diaphragm deflects for opening the valve.

In another embodiment a diaphragm valve is formed from a body comprising a chamber in the actuation layer and the in the fluidics layer, but without an interruption. In this embodiment, deforming the diaphragm into the actuation chamber creates a volume to accept fluid, and deforming the diaphragm into the fluidics chamber pumps liquid out of the chamber. In this configuration, the position of the diaphragm alters the effective cross-section of the fluidic conduit and, thus, can regulate the speed of flow through the valve. In such a configuration, the valve may not completely block the flow of fluid in the conduit.

The location on a mating face of the actuation layer that faces a valve seat can comprise a concavity that functions as a valve relief. The shape of the concavity can define the valve chamber, as the elastic layer, when deflected into the valve relief, creates a volume on the fluidic side. So, for example, the valve relief can have a shape that surrounds the valve inlet and valve outlet on the opposite side of the diaphragm, for example a circular chamber. The valve relief, or any portion of an actuation layer in communication with a valve diaphragm, communicates with a conduit in the actuation layer that transmits positive or negative pressure for actuating the diaphragm.

Valves with concave valve seats displace defined volumes of liquid upon closing. Therefore, such valves are useful as pumps where pumping of uniform volumes is desired. Different batches of material used in the elastic layer or different regions of elastic material in a single device can have different elasticity. Such materials may deform by different amounts under the same differential pressure. Valves of this invention can be configured so that within normal specifications for the material, under the same differential pressure, it will deform to fill the entire valve chamber, thereby producing a defined pump volume across parallel pumps in a series of circuits. Typically, pumping valves have greater volumes than gating valves. For example, a pumping valve can have a displacement volume of between 50 μL to 150 μL, e.g., about 100 μL. Two pumping valves can be placed in series, e.g., without intervening features, to provide variable volume pumps. Such pumping valves typically are placed between two closing valves that function as pump inlets and pump outlets. The series of pumping valves can include more than two pumping valves. The valves can be configured to have different stroke volumes so that actuating different combinations of valves produces predetermined volumes of liquid. So, for example, if a first pumping valve pumps a volume of 100 microliters and a second pumping valve pumps a volume of 50 microliters, this combination can be actuated to pump 50 microliters, 100 microliters or 150 microliters.

By controlling a miniaturized off-chip solenoid, vacuum or pressure (approximately one-half atmosphere) can be applied to PDMS membrane to open or close the valve by simple deformation of the flexible membrane, e.g., application of vacuum to the membrane deflects the membrane away from a valve seat, thereby opening the valve.

Diaphragm valves of this invention can displace defined volumes of liquid. A diaphragm valve can displace a defined volume of liquid when the valve is moved into a closed or opened position. For example, a fluid contained within a diaphragm valve when the valve is opened is moved out of the diaphragm valve when the valve is closed. The fluid can be moved into a microchannel, a chamber, or other structure. The diaphragm valve can displace volumes that are about, up to about, less than about, or greater than about 500, 400, 300, 200, 100, 50, 25, 20, 15, 10, 5, 4, 3, 2, 1, 0.5, 0.25, 0.1, 0.05 or 0.01 μL. For example, the displacement volume can be between about 10 mL to 5 μL, e.g., about 100 mL to about 500 mL.

Variations on flow-through and in-line valves can include valves that are situated at intersections of greater than two, three, four, or more channels. Valve seats or other structures can be designed such that closure of the valve can prevent or reduce flow in one or more of the channels while allowing fluid to flow in one or more of the other channels. For example flow can be blocked along three of five channels, while flow can continue through two of the five channels. A flow-through valve can also be referred to as a T-valve, as described in WO 2008/115626.

When at least three valves are placed in a series a positive displacement pump is created. The series can comprise a first diaphragm valve with a valve seat, a pumping diaphragm valve without a valve seat and a second diaphragm valve with a valve seat. (See FIG. 5.) Positive displacement diaphragm pumps are self-priming and can be made by coordinating the operation of the three valves (including but not limited to, 4, 5, 6, 7, 8, 9, 10, 11, 12, 13, 14, 15, 16, 17, 18, 19, or 20 or more valves), and can create flow in either direction. A variety of flow rates can be achieved by the timing of the actuation sequence, diaphragm size, altering channel widths, and other on-chip dimensions. Routers can similarly be formed from these valves and pumps. The routers can be formed using three or more valves each on a separate channel connecting to central diaphragm valve. A router also can be made by configuring three channels, each comprising a diaphragm pump, to meet in a common chamber, e.g. a pumping chamber. Bus structures can also be created that employ a series of at least two flow-through valves in which intersecting channels intersect the same flowthrough channel.

To operate a three-part diaphragm pump, a first valve is opened and a third valve is closed. Then, the second, or middle, pump is opened, drawing liquid through the first valve and into the chamber of the second valve. Then, the first valve is closed, the third valve is opened. Then, the second valve is closed, pumping liquid in the chamber through the third valve. For example, moving the diaphragm into the valve relief creates an intake stroke that pulls fluid into the valve chamber when the valve inlet is open and the valve outlet is closed. Then, moving the diaphragm toward the valve seat creates a pump stroke that pushes the fluid out of the valve chamber when the valve inlet is closed and the valve outlet is open.

The diaphragm valves, pumps, and routers are durable, easily fabricated at low cost, can operate in dense arrays, and have low dead volumes. Arrays of diaphragm valves, pumps, and routers are readily fabricated on substrates. In one embodiment, all the diaphragm valves, pumps, and routers on a microchip are created at the same time in a simple manufacturing process using a single or monolithic membrane, such as a sheet of PDMS. It costs the same to make five diaphragm pumps on a chip as it does to create five hundred. This technology provides the ability to create complex micro- and nanofluidic circuits on microchips and integrate chemical and biochemical processes by using the circuits. Thus, the disclosure herein provides methods and the ability to create simple and complex micro-, nano-, and pico-fluidic circuits on chips, and allows the implementation of virtually any reaction or assay onto a chip. In general, this technology can be at least substantially insensitive to variations in solution ionic strength and surface contamination, and does not require applied electric fields.

A microfluidic device typically will comprise a plurality of fluidics circuits, each circuit comprising a microfluidic conduit in communication with external entry and exit ports. Circuits typically comprise channels and functional elements, such as valves, routers, pumps (e.g., three independently operable valves in series) and chambers.

In certain embodiments, the microfluidic devices of this invention are monolithic devices. In monolithic devices, a plurality of circuits are provides on a single substrate. In the case of devices comprising diaphragm valves, a monolithic device comprises a single elastic layer functioning as a diaphragm for a plurality of valves. In certain embodiments, one actuation channel can operate a plurality of valves on a monolithic device. This allows parallel activation of many fluidic circuits. Monolithic devices can have dense arrays of microfluidic circuits. These circuits function with high reliability, in part because the channels in each circuit are fabricated simultaneously on a single substrate, rather than being made independently and assembled together. In other embodiments, an actuation conduit can control actuation of a single valve. For example, the actuation conduit can traverse the actuation layer from the actuation surface to the other side.

The fluidic circuits and actuation circuits of these chips are densely packed. A circuit comprises an open or closed conduit. In certain embodiments, the device can comprise at least 1 fluidic circuit per 1000 mm², at least 2 fluidic circuits per 1000 mm², at least 5 fluidic circuits per 1000 mm², at least 10 fluidic circuits per 1000 mm², at least 20 fluidic circuits per 1000 mm², at least 50 fluidic circuits per 1000 mm². Alternatively, the device can comprise at least 1 mm of channel length per 10 mm² area, at least 5 mm channel length per 10 mm², at least 10 mm of channel length per 10 mm² or at least 20 mm channel length per 10 mm². Alternatively, the device can comprise valves (either seated or unseated) at a density of at least 1 valve per cm², at least 4 valves per cm², or at least 10 valves per cm². Alternatively, the device can comprise features, such as channels, that are no more than 5 mm apart edge-to-edge, no more than 2 mm apart, no more than 1 mm apart, no more than 500 microns apart or no more than 250 microns apart.

In other embodiments, the device can comprise at most 1 fluidic circuit per 1000 mm², at most 2 fluidic circuits per 1000 mm², at most 5 fluidic circuits per 1000 mm², at most 10 fluidic circuits per 1000 mm², at most 20 fluidic circuits per 1000 mm², at most 50 fluidic circuits per 1000 mm². Alternatively, the device can comprise at most 1 mm of conduit length per 10 mm² area, at most 5 mm conduit length per 10 mm², at most 10 mm of conduit length per 10 mm² or at most 20 mm conduit length per 10 mm². Alternatively, the device can comprise valves (either seated or unseated) at a density of at most 1 valves per cm², at most 4 valves per cm², or at most 10 valves per cm². Alternatively, the device can comprise features, such as channels, that are no less than 5 mm apart edge-to-edge, no less than 2 mm apart, no less than 1 mm apart, no less than 500 microns apart or no less than 100 microns apart.

The devices of this invention have very low failure rates. A chip is considered to fail when at least one fluidic circuit fails to perform. Failure can result from delamination of the sandwich, for example when bonding between the layers fails, or from sticking of the elastic layer to functional portions of the fluidics or elastic layers, such as sticking to valve seats, valve chambers or channels on the layer surface that are exposed to the elastic layer.

The devices of this invention can perform more high reliability. A batch of chips according to this invention have failure rates of less than 20%, less than 10%, less than 1% or less than 0.1%. Valves of this invention can have a failure rate of less than 1% over 1,000 actuations, 10,000 actuations or 100,000 actuations. A batch can be at least 10, at least 50 or at least 100 devices.

3. Methods of Making

3.1 Fluidics and Actuation Layers

The fluidics and/or actuation layers of the device may be made out of various materials selected from those including, but not limited to, glass (e.g., borosilicate glasses (e.g., borofloat glass, Corning Eagle 2000, pyrex), silicon, quartz, and plastic (e.g., an olefin co-polymer (e.g., Zeonor), a cycloolefin polymer (“COP”), a cycloolefin co-polymer (“COC”), an acrylic, a liquid crystal polymer, polymethylmethoxyacrylate (PMMA), a polystyrene, a polypropylene, and a polythiol). Depending on the choice of the material different fabrication techniques may also be used. In certain fluidic devices of this invention, the plastic substrate can be a flat and/or rigid object having a thickness of about 0.1 mm or more, e.g., about 0.25 mm to about 5 mm.

In some embodiments microstructures of channels and vias are formed using standard photolithography. For example, photolithography can be used to create a photoresist pattern on a glass wafer, such as an amorphous silicon mask layer. In one embodiment, a glass wafer comprises of a 100 μm thick glass layer atop a 1 μm thick glass layer on a 500 μm thick wafer. To optimize photoresist adhesion, the wafers may be exposed to high-temperature vapors of hexamethyldisilazane prior to photoresist coating. UV-sensitive photoresist is spin coated on the wafer, baked for 30 minutes at 90° C., exposed to UV light for 300 seconds through a chrome contact mask, developed for 5 minutes in developer, and post-baked for 30 minutes at 90° C. The process parameters may be altered depending on the nature and thickness of the photoresist. The pattern of the contact chrome mask is transferred to the photoresist and determines the geometry of the microstructures.

A piece may be made out of plastic, such as polystyrene, using a hot embossing technique. The structures are embossed into the plastic to create the bottom surface. A top layer may then be bonded to the bottom layer. Injection molding is another approach that can be used to create such a device. Soft lithography may also be utilized to create either a whole chamber out of plastic or only partial microstructures may be created, and then bonded to a glass substrate to create the closed chamber. Yet another approach involves the use of epoxy casting techniques to create the obstacles through the use of UV or temperature curable epoxy on a master that has the negative replica of the intended structure. Laser or other types of micromachining approaches may also be utilized to create the flow chamber. Other suitable polymers that may be used in the fabrication of the device are polycarbonate, polyethylene, and poly(methyl methacrylate). In addition, metals like steel and nickel may also be used to fabricate the master of the device of the invention, e.g., by traditional metal machining. Three-dimensional fabrication techniques (e.g., stereolithography) may be employed to fabricate a device in one piece. Other methods for fabrication are known in the art.

Features on a piece can be provided with asymmetric draft angles. The draft angle refers to the angle of a feature with respect to the radial axis of the feature. Typically, an indented feature will narrow away from the base, e.g., forming a section of a cone rather than a section of a cylinder. Features with asymmetric draft angles are not radially symmetric with respect to the axis of the feature extending perpendicular to the surface of the piece. Molded plastic pieces tended to shrink toward the center of mass when cooling. In the present case the draft angle of a side of a feature closer to the center of part shrinkage of a piece is more acute than the draft angle of a side of a feature further from the center of part shrinkage. Asymmetric draft angles assist in removing a piece from a mold. Asymmetric draft angles can be used on features having a high aspect ratio, e.g., an aspect ratio of at least 3:1. Generally, the farther away from the center of shrinkage, the greater the asymmetry of the draft angles of the feature.

A moat or trench can be formed around at least part of a non-microfluidic well. The moat or trench can be filled with a liquid whose temperature can be regulated, thereby regulating the temperature of liquid in the non-microfluidic wells and normalizing across the wells. For example, a heating bar can be remarkably inserted into the moat or trench to regulate the temperature of the liquid therein.

A piece having a plurality of fluidics circuits can be provided with a common waste system. The waste system is configured to collect liquids from each of the fluidic circuits and routes them to a common port that exits the piece.

The microfluidic device typically comprises multiple microchannels and vias that can be designed and configured to manipulate samples and reagents for a given process or assay. In some embodiments the microchannels have the same width and depth. In other embodiments the microchannels have different widths and depths. In another embodiment a microchannel has a width equal to or larger than the largest analyte (such as the largest cell) separated from the sample. For example, in some embodiments, a microchannel in a microfluidics chip device can have a cross-sectional dimension between about 25 microns to about 500 micron, e.g., about 100 microns, about 150 microns or about 200 microns. In other embodiments, the channels have a width greater than 50, 60, 70, 80, 90, 100, 110, 120, 130, 140, 150, or 300 microns. In some embodiments, a microchannel has a width of up to or less than 100, 90, 80, 70, 60, 50, 40, 30 or 20 microns. In some embodiments a microchannel in a microstructure can have a depth greater than 50, 60, 70, 80, 90, 100, 110, 120, 130, 140 or 150 microns. In some embodiments, a microchannel has a depth of up to or less than 100, 90, 80, 70, 60, 50, 40, 30 or 20 microns. In some embodiments a microchannel has side walls that are parallel to each other. In some other embodiments a microchannel has a top and bottom that are parallel to each other. In some other embodiments a microchannel comprises regions with different cross-sections. In some embodiments, a microchannel has a cross-section in the shape of a wedge, wherein the pointed end of the wedge is directed downstream.

3.2 Elastic Layer

The elastic layer can be a smooth or flat, e.g., unsculpted, layer. Typically, a single monolithic piece of elastic material covers a surface of a fluidics layer and an actuation layer into which a plurality of functional elements, such as conduits, valves and chambers, are introduced. In a sandwich format, surfaces of the fluidics layer and actuation layer contact the elastic layer and are covered by it. A single elastic layer can provide diaphragms for a plurality of valves. In other embodiments, the elastic layer can be sculpted to create thinner or thicker regions. Such regions can provide useful volumes or have altered flexibility (thinner layers being more flexible).

The elastic layer typically is formed of a substance that can deform when vacuum or pressure is exerted on it and can return to its un-deformed state upon removal of the vacuum or pressure, e.g., an elastomeric material. Because the deformation dimension is measured in less than ten mm, less than one mm, less than 500 um, or less than 100 um, the deformation required is lessened and a wide variety of materials may be employed. Generally, the deformable material has a Young's modulus having a range between about 0.001 GPa and 2000 GPa, preferably between about 0.01 GPa and 5 GPa. Examples of deformable materials include, for example but are not limited to thermoplastic or a cross-linked polymers such as: silicones (e.g., polydimethylsiloxane), polyimides (e.g., Kapton™, Ultem), cyclic olefin co-polymers (e.g., Topas™, Zeonor), rubbers (e.g., natural rubber, buna, EPDM), styrenic block co-polymers (e.g., SEBS), urethanes, perfluoro elastomers (e.g., Teflon, PFPE, Kynar), Mylar, Viton, polycarbonate, polymethylmethacrylate, santoprene, polyethylene, or polypropylene. Other classes of material that could function as the elastic layer include, for example, but are not limited to metal films, ceramic films, glass films or single or polycrystalline films. Furthermore an elastic layer could comprise multiple layers of different materials such as combination of a metal film and a PDMS layer.

3.3. Assembly

The devices of this invention are assembled so that the functional portions, such as valves, pumps, reservoirs and channels, are sealed to prevent leakage of fluids, and the elastic layer does not stick to functional exposed surfaces.

In one method, the layers are sealed by bonded together with covalent or non-covalent bonds (e.g., hydrogen bonds). This can be achieved by mating the fluidics, elastic and actuation layers together as a sandwich and applying pressure and heat. For example, when the elastic layer comprises a silicone, such as PDMS treated as above to render the surface more hydrophilic, and the fluidics and actuation layers are glass treated to render the exposed surfaces more hydrophobic, the pieces can be pressed together at a pressure of 100 kg to 500 kg, e.g., about 300 kg. They can be baked between 25° C. and 100° C., e.g., about 90° C. for about 5 minutes to about 30 minutes, e.g., about 10 minutes, depending on the combination of temperature and pressure used. This will cure the bonding between the elastic layer and the sealing surfaces.

In another method, the device can be assembled by holding the pieces together under pressure during functioning of the chip, thereby sealing the functional areas of the fluidics layer from leakage. This can be done mechanically, e.g., by clipping or clamping the layers together.

To improve the seal between the elastic layer, such as PDMS, and the fluidics and actuation layers, the elastic layer can be subjected to treatments to activate reactive groups on the surface that will bond with reactive groups on the surface of the fluidics and elastic layers. In another embodiment, selective regions of the elastic layer can be activated or deactivated. For example, in one embodiment, the elastic layer comprises a silicone polymer, (polysiloxane) such as poly(dimethylsiloxane) (PDMS). Silicones typically are water repellant due, in part, to an abundance of methyl groups on their surfaces. In order to increase the strength of bonding between polysiloxanes and substrates comprising reactive groups, such as hydroxyls (e.g., glass), the siloxanes can be made more hydrophilic by UV ozone, plasma oxidation, or other methods that places silanol groups (Si—OH) on the surface. When activated PDMS is contacted with glass or other materials comprising active hydroxyl groups and preferably subjected to heat and pressure, a condensation reaction will produce water and covalently bond the two layers through, e.g., siloxane bonds. This produces a strong bond between the surfaces.

In order for the valves to be functional, the elastic layer cannot bind to the valve seats, and, preferably, does not bind to any surface of the valve or to any channel in the surface of the fluidic or elastic layer that faces the elastic layer. This invention contemplates various methods of decreasing sticking of the elastic layer to functional surfaces.

In one embodiment, immediately after bonding, the channels are flushed with liquid to open any closed valves.

In another method, functional surfaces are coated with a low energy material before bonding with the elastic layer. For example, devices of this invention also can be provided that have functional surfaces treated to decrease their surface energy. Low surface energies decrease sticking of the elastic layer to the fluidics or actuation layer to which it is attached. When the elastic layer is a silicone, such as poly(dimethylsiloxane) (PDMS), the water contact angle of the treated surface should be at least 90°, at least 100° degrees, at least 115°, at least 120° degrees or at least 140° degrees. Such methods are described in more detail in. Patent Publication 2010/0303687, Blaga et al., Dec. 2, 2010.

Many materials are useful to create low surface energies on exposed surfaces. In one embodiment, the material is a low energy polymer such as a perfluorinated polymer or a poly(p-xylylene) (e.g., parylene). Teflon is a known low surface energy material, which is also inert and biocompatible. The material can be a self-assembled monolayer. Self-assembled monolayers can be made from silanes, including for example, chlorosilanes or from thiol alkanes. They typically have a thickness between about 5 Angstroms and about 200 Angstroms. The low energy material can be a metal (e.g., a noble metal such as gold, silver or platinum). Other materials that can be used to provide low surface energy surfaces include hard diamond, diamond-like carbon (DLC) or a metal oxide (e.g., titania, alumina or a ceramic).

Perfluorinated polymers include, for example, Teflon-like materials deposited from fluorinated gases, PTFE (polytetrafluoroethylene, Teflon®), PFA (perfluoroalkoxy polymer resin), FEP (fluorinated ethylene-propylene), ETFE (polyethylenetetrafluoroethylene), PVF (polyvinylfluoride), ECTFE (polyethylenechlorotrifluoroethylene), PVDF (polyvinylidene fluoride) and PCTFE (polychlorotrifluoroethylene). The material can have a thickness of about 100 Angstroms to about 2000 Angstroms.

In one embodiment, the material comprises a noble metal, such as gold. The noble metal can be applied directly to the surface to be coated. Also, the noble metal can be applied to a surface already coated with another material, such as a refractory metal that facilitates adhesion of the noble metal to the surface. Refractory metals include, for example, chromium, titanium, tungsten, molybdenum, niobium, tantalum and rhenium. For example, a 1000 Angstrom layer of chromium can be applied to selective surfaces, followed by a 2000 Angstrom layer of gold. The chromium layer need only be thick enough to allow the gold to adhere, for example, at least 30 Angstroms, at least 50 Angstroms, at least 100 Angstroms, at least 500 Angstroms or at least 1000 Angstroms. The noble metal, also, need only be thick enough to inhibit binding of the elastic layer. For example the noble metal can have a thickness of at least 50 Angstroms, at least 100 Angstroms, at least 500 Angstroms, at least 1000 Angstroms or at least 2000 Angstroms. The metal can be applied by sputtering, evaporation, or atomic layer deposition using a shadow mask that exposes the surfaces to be coated, or by other techniques. Sputtering can use, for example, Rf or DC energy.

Another method improves bonding between plastic pieces and an elastic layer, particularly made of a siloxane. This method involves coating the plastic piece with a material that can produce hydroxyl groups that can react with activated siloxane. For example, the material can be a polysiloxane or a metal oxide. When subjected to UV ozone or oxygen plasma, these materials easily form bonds with activated polysiloxanes. Such methods are described in more detail in U.S. patent application Ser. No. 12/949,623, filed Nov. 18, 2010.

More specifically, the devices of this invention can comprise a first plastic substrate (e.g., an article or a layer) having a surface coated with a material having reactive groups or on which reactive groups can be introduced for covalent bonding with another material. The material can be a hydroxyl-generating material, that is, a material onto which hydroxyl groups can be introduced, for example by exposure to energy and an environment comprising oxygen gas. Such articles can be covalently bonded to a second substrate having surface hydroxyl groups, e.g., silanol groups, through ether bonds, e.g., siloxy (Si—O—X) bonds, between the surface material and the opposing surface. If both surfaces comprise silanol groups, then the bonds can be siloxane (Si—O—Si) bonds. In certain embodiments, the surface of the plastic article comprises at least one or a plurality of selected locations (e.g., a pattern) at which the plastic article is not bonded to the second substrate, for example, wherein the material on the surface of the plastic article has been treated to render the surface free of reactive groups with which to engage in binding to the surface of the second substrate. In certain embodiments, the article comprises a third substrate bonded to a second surface of the second substrate. The third substrate can comprise a plastic comprising a material or can be another material having surface reactive groups, such as hydroxyl groups, through which the third substrate is chemically bound to the second substrate.

All or part of an exposed or functional surface of a device of this invention can be a non-adhered selected location, e.g., by rendering it un-reactive with the second substrate. In certain embodiments, any surface likely to come into contact with an elastic layer during operation of a fluidic device can be a non-adhered selected location. For example, all or part of the surface of the valve seat is a non-adhered selected location. In this way, a valve is less likely to become stuck shut during manufacture or use thus producing a more reliable valve and device. Also, all or part of any other exposed surface in a valve or pump body also can be made unreactive with second substrate, including the all or part of the chambers in the actuation layer or the fluidics layer that form a valve body. In particular, surfaces of an actuation valve body can be non-adhered selected locations. All or part of fluidic or actuation channels that are exposed to the surface also can be configured to be non-adhered selected locations. The portions of the exposed fluidic or actuation surfaces can be configured to be unreactive with the second substrate enables selective bonding of the second substrate, e.g., an elastomer, to areas of a valve.

Certain functional surfaces in the fluidics layer can be functionalized to have chemical or biochemical binding functionalities attached thereto. These surfaces typically will include functional surfaces of seated or unseated valves. In various embodiments, valve seats and/or functional surfaces that not part of a valve, such as a channel or a chamber in the fluidics layer that does not oppose a chamber in the actuation layer. These materials can selectively or specifically bind analytes. For example, the binding functionality could be a nucleic acid, a metal or metal chelate, a carbohydrate or a protein, such as an antibody or antibody-like molecule, enzymes, biotin, avidin/streptavidin, etc.

These materials can be bound to surfaces, e.g., valve chamber surfaces, by any attachment chemistry known in the art. For example, a surface can be derivatized with a functionalized silane, such as an amino silane or an acryl silane, and the functional group reacted with a reactive group on the molecule comprising the binding functionality.

4. System

A fluidic system can comprise a fluidic assembly and an actuation assembly. The fluidic assembly can comprise (1) elements to engage and hold the fluidic portion of a microfluidic device that comprises microfluidic elements, e.g., fluidic conduits, and (2) a fluid delivery assembly, such as a robot, configured to deliver fluids to the fluidic manifold or to the microfluidic conduits directly. The actuation assembly can comprise (1) elements to engage and hold the actuation portion of a microfluidic device that comprises actuation conduits, (2) an actuation manifold configured to mate or align with ports on the microfluidic device and to deliver actuant into the actuation conduits microfluidic device; and (3) an actuant delivery assembly, configured to deliver actuant to the actuation manifold or to the actuation conduits directly. The actuant delivery assembly can comprise a source of positive or negative pressure and can be connected to the actuation conduits through transmission lines.

The instrument can also comprise accessory assemblies. One such assembly is a temperature controller configured to control temperature of a fluid in a fluidic conduit. Another is a source of magnetic force, such as a permanent or electromagnet, configured to apply magnetic force to containers on the instrument that can comprise, for example, particles responsive to magnetic force. Another is an analytic assembly, for example an assembly configured to receive a sample from the fluidic assembly and perform a procedure such as capillary electrophoresis that aids detection of separate species in a sample. Another is a detector, e.g., an optical assembly, to detect analytes in the instrument, for example fluorescent or luminescent species. The instrument also can comprise a control unit configured to automatically operate various assemblies. The control unit can comprise a computer comprising code or logic that operates assemblies by, for example, executing sequences of steps used in procedure for which the instrument is adapted.

5. Methods of Use

The monolithic fluidic pieces of this invention are useful in the construction of microfluidic devices, in particular MOVe devices, and for performing manipulations of fluids in the micro- and macro-environments.

The devices of this invention can be used to manipulate fluidics and perform chemical or biochemical reactions on them. In certain embodiments, the devices are useful to perform one or more steps in a sample preparation procedure. For example, a fluidics robot can load a non-microfluidic (e.g., macrofluidic) sample containing an analyte from a 96-well microtiter plate to a non-microfluidic well of a device of this invention. The robot also can load reagents onto other non-microfluidic wells of the device that are part of the same fluidic circuit. On-device circuitry, such as diaphragm valves and pumps, can divert fluids into the same chamber for mixing and reaction. A temperature regulator can transmit heat to a chamber, for example, to perform thermal cycling or to “heat-kill” enzymes in a mixture. Fluids can be shuttled between chambers in preparation of further steps. Analytes can be captured from a volume by contacting the fluid with immobilized specific or non-specific capture molecules. For example, chambers can have immobilized biospecific capture agents. Also, fluids comprising magnetically reactive particles that capture analytes can be mixed with fluids comprising the analyte in various chambers in the device. The particles can be immobilized with a magnetic force and washed to remove impurities. Then the purified analyte can be eluted from the particles and transmitted to an exit chamber for removal from the device.

### EXAMPLES

### Example 1

### Fabrication of a Monolithic Fluidic Piece and MOVe Device

Plastic Injection Molding.

An injection mold is fabricated using, but not limited to, CNC machining equipment, and or E-form plating of nickel onto an etch shape on a wafer of material. The mold can be finished with plating process of polishing processes.

Plastic, in this case COC (Zeonor), is then injected into the preheated mold using an injection molding machine. The injection pressure (about 12,000 psi) is then maintained and extended period of time over a typical shot time (e.g., 6 seconds) to fill in any micro-features in the mold. The temperature is about 530 degrees F. The plastic monolithic fluidic device (part) is then extracted from the mold using ejector pins or rails. The gates and flash are removed from the part.

Compression Molding.

A compression mold is fabricated using, but not limited to, CNC machining equipment, and or E-form plating of nickel onto an etch shape on a wafer of material. The mold can be finished with plating process of polishing processes. Mold temperature is about 400 degrees F.

Plastic in pellet or sheet form is then placed in the heated compression molding system. The mold is compressed to form the monolithic fluidic device (part). Typical conditions are ten minutes at 20 tons of force.

Post Anneal and Flatting Step

### (To be Performed for Both Injection Molding or Compression Molding Process)

The plastic monolithic fluidic device (part) can then be inserted into a specially designed flattening jig. This jig is designed to closely follow the profile of the non-microfluidic features of the part and have significantly flat regions where microfluidic structures are located. In the case where all microfluidic structures are on one side, a hot piece of float glass is used as a flattening surface. The flattening jig is also designed in such a way to create a cavity that is generally shorter, in the direction of press force, than the actual molded part. One example of this difference in height between part and flattening jig would be −25 um. This allows the molded part to extend beyond the jig and allow the entire surface of the part, to be shaped, to be exposed to the pressure and heat of the press. The part will plastically deform by a small amount to equalize the stress profile and create the desired flattening effect. The temperature of the press is generally set at, or above, the Glass Transition point of the material. The press is then actuated with a force sufficient to deform the plastic to flatten and anneal it. An example of this force is 200 Lbs-force. The system is then held at this state for several minutes. The temperature is then slowly reduced at the rate appropriate for annealing and stress reduction as defined by the material properties.

The Part is then removed from the jig and cleaned for assembly.

### Example 2

### Use of MOVe Device for DNA Library Construction

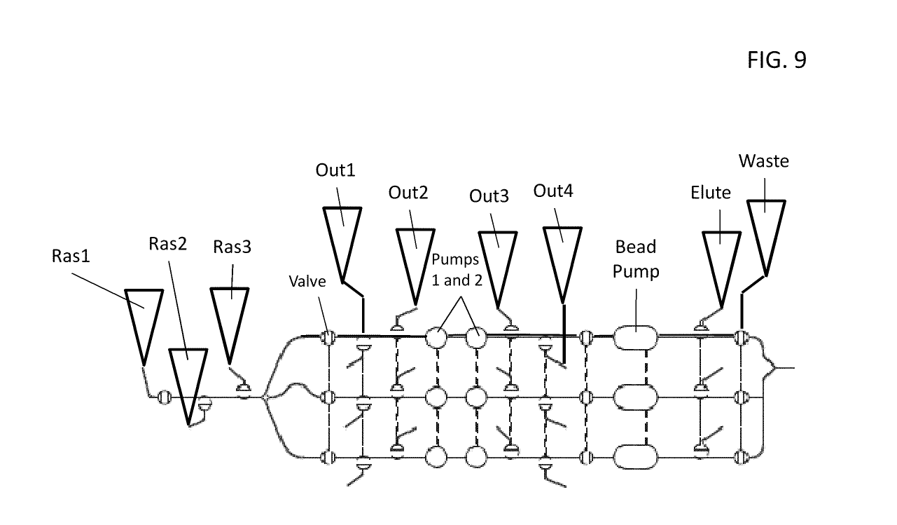

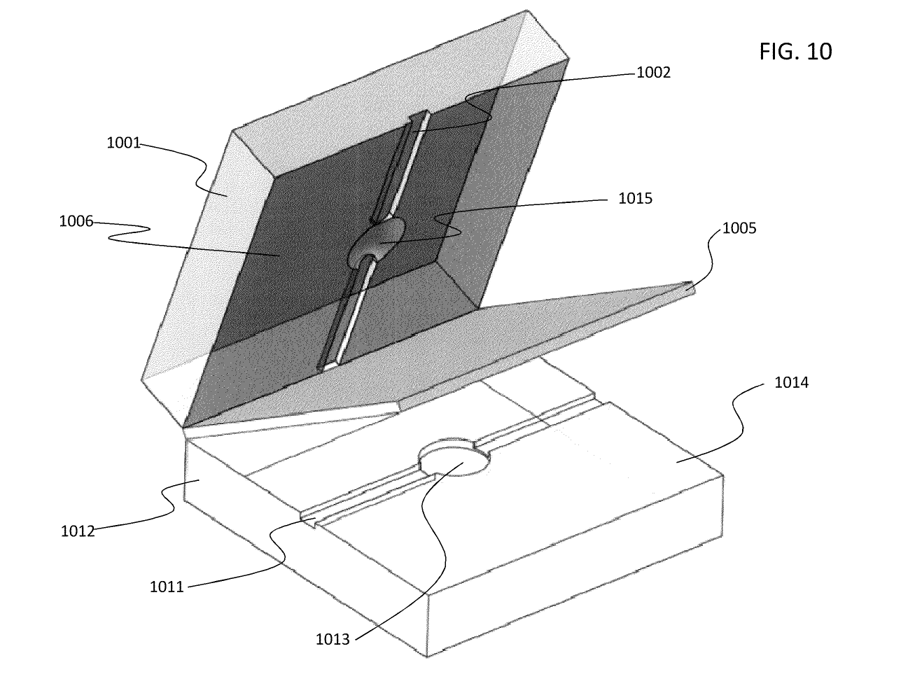

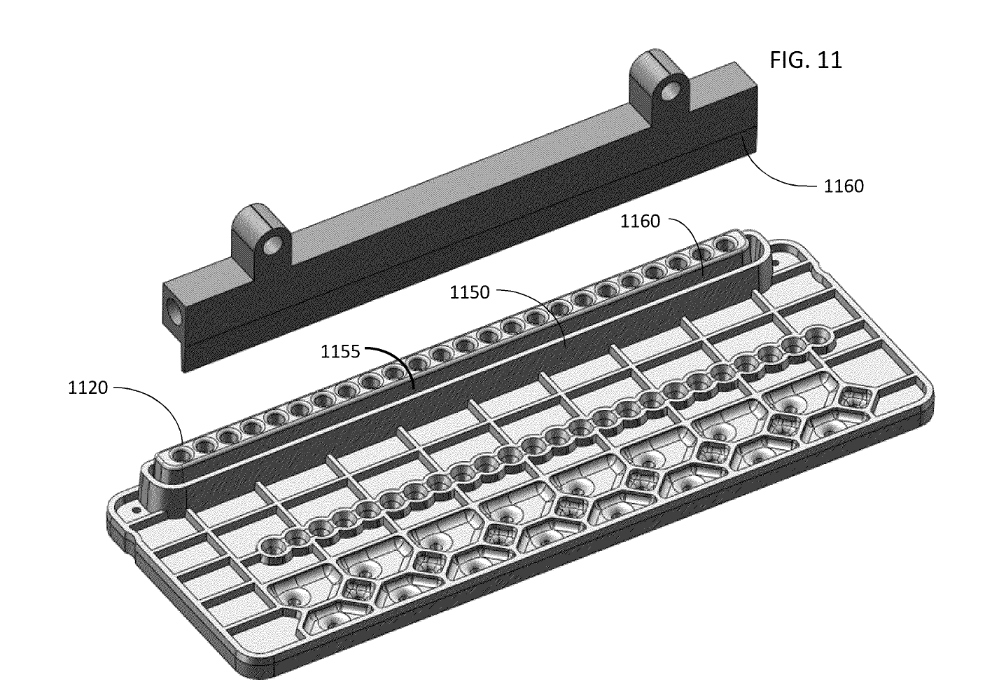

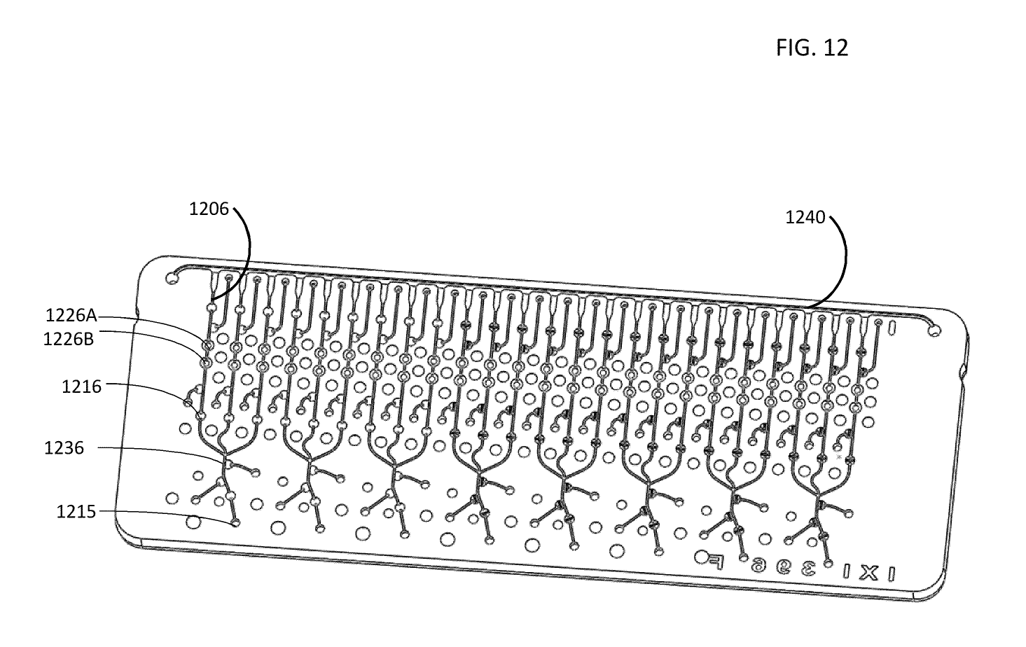

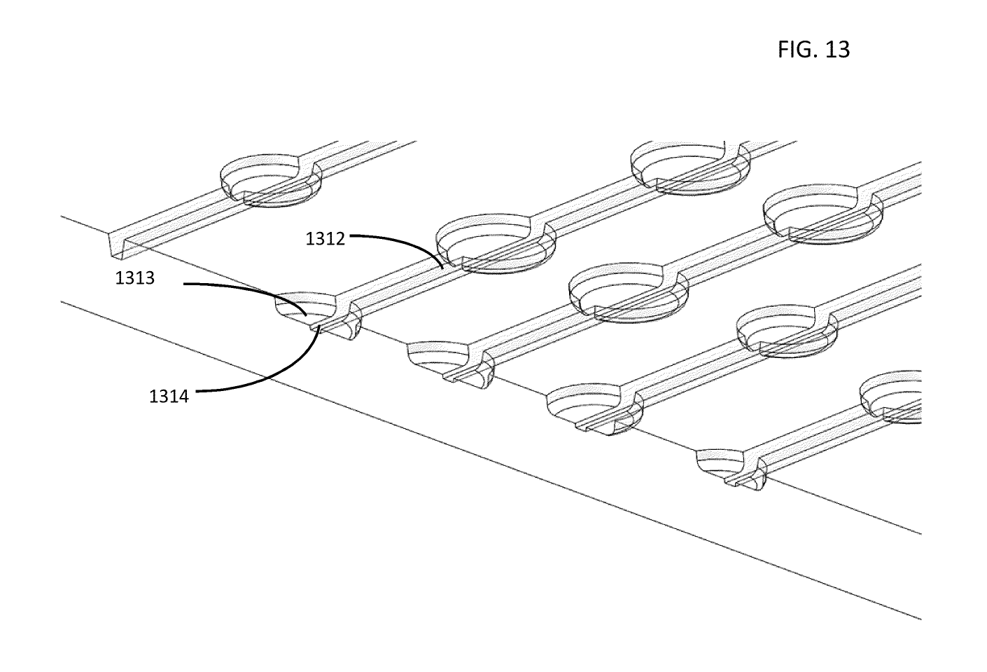

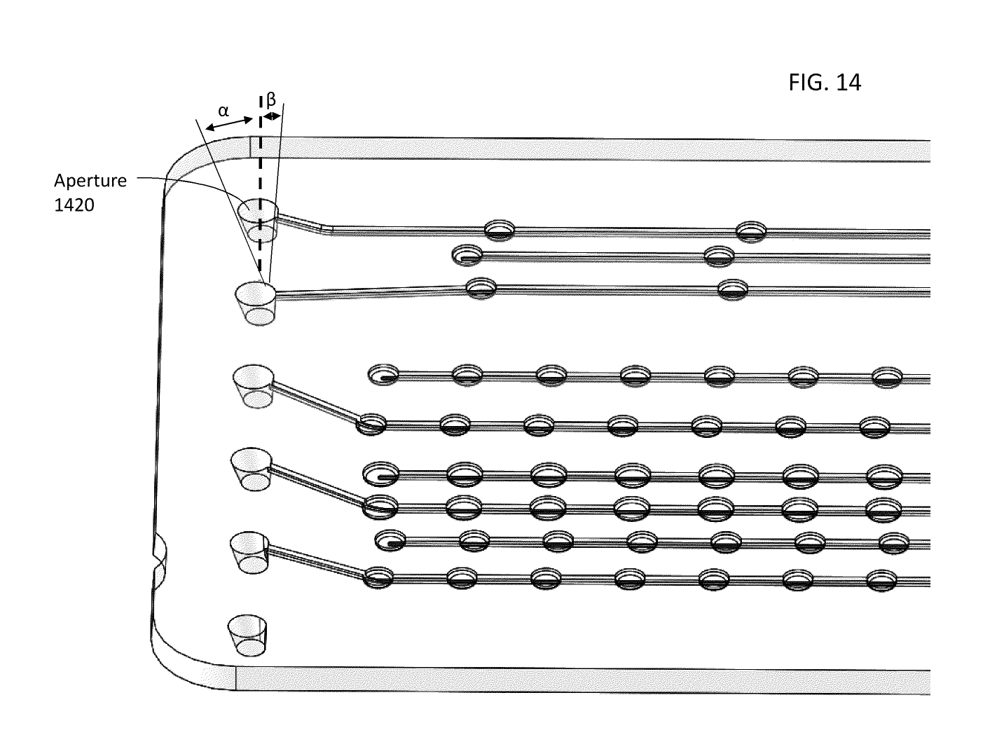

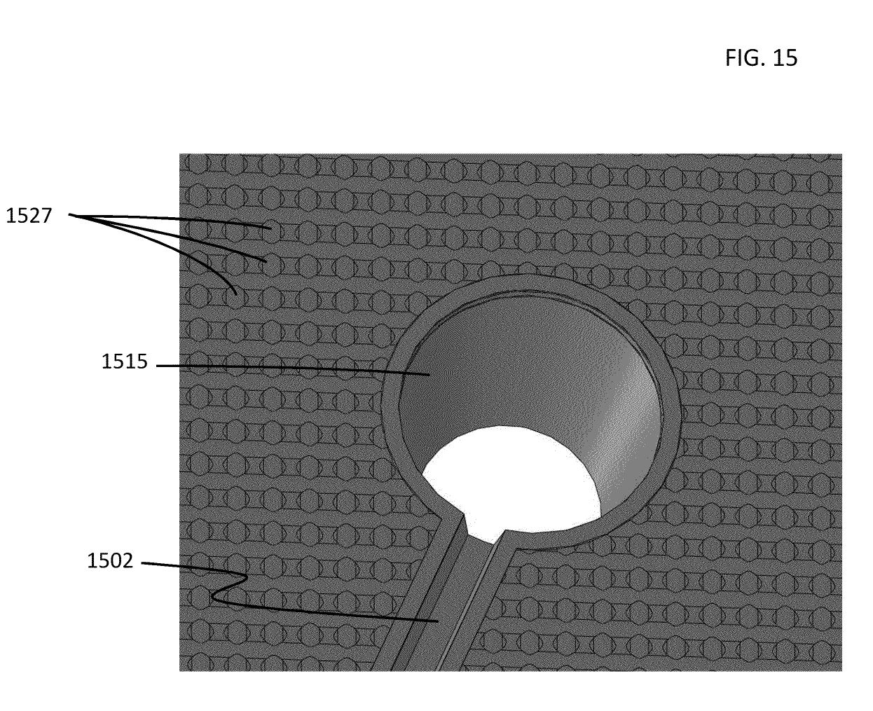

A device of this invention is used to prepare an adaptor-linked DNA library from a sample of DNA fragments. FIG. 9 shows the architecture of a fluidic device. Fluidic elements are shown in solid line and actuation elements in dotted line. Ras1, Ras2, Ras3, Out1, Out2, Out3, Elute and Waste are non-microfluidic compartments on one side of the device connected to microfluidic channels on a surface of the device. The surface comprises valves comprising valve seats and pumps in which the elastic layer faces a void rather than a valve seat and is configured to pump defined volumes of liquid.

Creation of an adaptor library from DNA fragments includes four main parts: (1) Blunt-ending the DNA fragments, (2) A-tailing the blunt ended fragments, (3) adaptor ligation and (4) DNA purification. Non-microfluidic volumes are loaded into the non-microfluidic compartments unless otherwise noted. Loading typically is performed by fluidics robot. Typically, when a fluid is pumped, the system is first primed with the liquid by pumping through the channels into Waste. These steps are not mentioned below.

1. Blunt-Ending

The blunt-end step proceeds as follows, a sample comprising DNA fragment is loaded in Out2, SPRI beads are loaded in Out4, Blunt-end master mix is loaded in Ras1, Fluorinert is loaded in Ras2 and Bead reagents are loaded in Ras3. The protocol proceeds as follows:
1. Pump aliquot-1 of Fluorinert into Out1
2. Pump aliquots of Sample and Blunt-ending Master mix into Out1 in layers to aid mixing.
3. Pump aliquot-2 of Fluorinert into Out1
4. Incubate the mixture at room temperature
5. Transfer heat through wall of Out1 to heat-kill enzymes at 75 degrees C.
6. Pump aliquot-2 of Fluorinert to Waste
7. Pump reaction mixture to Out3
8. Pump aliquot-1 of Fluorinert to Waste
9. Rinse Ras1
10. Optionally rinse other microfluidic lines

2. A-Tailing
1. Load A-tailing master mix into Ras1
2. Pump aliquot-3 of Fluorinert into Out1
3. Pump aliquots of Reaction mixture and A-tailing Master mix into Out1 in layers to aid mixing.
4. Pump aliquot-4 of Fluorinert into Out1
5. Incubate the mixture at 37 degrees C.
6. Transfer heat through wall of Out1 to heat-kill enzymes
7. Pump aliquot-4 of Fluorinert to Waste
8. Pump 2^{nd} reaction mixture to Out3
9. Pump aliquot-3 of Fluorinert to Waste
10. Rinse Ras1
11. Optionally rinse other microfluidic lines

3. Adaptor Ligation
1. Load Adaptor ligation master mix into Ras1
2. Pump aliquot-5 of Fluorinert into Out1
3. Pump aliquots of 2^{nd} Reaction mixture and Adaptor ligation Master mix into Out1 in layers to aid mixing.
4. Pump aliquot-6 of Fluorinert into Out1
5. Incubate the mixture at room temperature
6. Transfer heat through wall of Out1 to heat-kill enzymes at 75 degrees C.
7. Pump aliquot-6 of Fluorinert to Waste
8. Pump 3^{rd} reaction mixture to Out3
9. Pump aliquot-5 of Fluorinert to Waste

4. Bead Clean-Up
1. Load Bead master mix into Ras3
2. Pump aliquots of 3^{rd} Reaction mixture and Bead Master mix into Out4 in layers to aid mixing.
3. Pump captured material to Bead Pump and immobilize beads with magnet
4. Add wash solution to Ras3
5. Pump wash solution over beads to wash beads
6. Pump air over beads to dry
7. Add water to Ras3
8. Pump water over beads to elute product
9. Pump eluant to Elute

### REFERENCES

U.S. Pat. No. 6,251,343; DUBROW et al., Jun. 26, 2001
U.S. Pat. No. 7,445,926; MATHIES et al., Nov. 4, 2008
U.S. Patent Publication 2004/0209354; MATHIES et al., Oct. 21, 2004
U.S. Patent Publication 2005/0161669, JOVANOVICH et al., Jul. 28, 2005
U.S. Patent Publication 2006/0073484; MATHIES et al., Apr. 6, 2006
U.S. Patent Publication 2007/0248958; JOVANOVICH et al., Oct. 25, 2007
U.S. Patent Publication 2008/0014576; JOVANOVICH et al., Jan. 17, 2008
U.S. Patent Publication 2010-0165784; JOVANOVICH et al., Jul. 1, 2010
U.S. Patent Publication 2010-0303687; BLAGA et al., Dec. 2, 2010
PCT Publication WO 2008/115626; JOVANOVICH et al., Sep. 25, 2008
PCT Publication WO 2009/108260; VANGBO et al., Sep. 3, 2009
PCT application PCT/US2010/40490; STERN et al., Jun. 29, 2010
PCT Publication WO 2010/141921; VANGBO et al., Dec. 9, 2010
PCT Publication WO 2011/011172; STERN et al., Jan. 27, 2011
Anderson et al., Nucleic Acids Res. 2000 Jun. 15; 28(12):E60
Zhang et al., “PMMA/PDMS valves and pumps for disposable microfluidics,” Lab Chip 2009 9:3088 (Aug. 20, 2009)

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. An article fabricated in one piece comprising at least one aperture through the piece, wherein the aperture defines a non-microfluidic volume, and a microfluidic channel formed in a surface of the piece onto which the aperture opens, wherein the channel is in fluidic communication with the aperture, wherein the aperture and the microfluidic channel define a fluidic circuit.

2. The article of claim 1 wherein the article comprises a polymer.

3. The article of claim 2 wherein the polymer is a polycarbonate, an olefin co-polymer (COC) (e.g., Zeonor), a cycloolefin co-polymer (COP), an acrylic, a liquid crystal polymer, polymethylmethoxyacrylate (PMMA), a polystyrene, a polypropylene, or a polythiol.

4. The article of claim 1 wherein the microfluidic channel is disposed on a surface of the article adapted for contact with an elastic layer for sealing the microfluidic channel.

5. The article of claim 4 wherein the surface adapted for contact is substantially planar.

6. The article of claim 4 wherein the surface adapted for contact comprises a non-smooth and/or patterned, surface.

7. The article of claim 1 comprising a first side and a second side oriented substantially opposite each other, wherein the aperture communicates between the two sides.

8. The article of claim 7 wherein the aperture opens onto a surface that comprises elements that increase the rigidity of the article.

9. The article of claim 1 wherein the fluidic circuit further comprises a second aperture through the piece, the second aperture defining a non-micro fluidic volume, wherein the second aperture is in fluidic communication with the microfluidic channel.

10. The article of claim 1 comprising a plurality of fluidic circuits.

11. A device comprising:
a) an article fabricated in one piece comprising at least one aperture through the piece, wherein the aperture defines a non-microfluidic volume, and a microfluidic channel formed in a surface of the piece onto which the aperture opens, wherein the channel is in fluidic communication with the aperture, wherein the aperture and the microfluidic channel define a fluidic circuit; and
b) an elastic layer covering and sealing the microfluidic channel.

12. The device of claim 11 further comprising:
c) an actuation piece having an actuation surface having an actuation channel therein, wherein the actuation surface contacts the elastic layer so that the elastic layer covers and seals the actuation channel and wherein the actuation channel is configured to transmit positive or negative pressure to the elastic layer opposite a valve seat in the fluidic structure.

13. An instrument comprising:
a) a device comprising:
i) an article fabricated in one piece comprising at least one aperture through the piece, wherein the aperture defines a non-microfluidic volume, and a microfluidic channel formed in a surface of the piece onto which the aperture opens, wherein the channel is in fluidic communication with the aperture, wherein the aperture and microfluidic channel define a fluidic circuit;
ii) an elastic layer covering and closing the microfluidic channel and configured to inhibit leaks of fluid from the microfluidic channel; and
iii) an actuation piece having an actuation surface having an actuation channel therein, wherein the actuation surface contacts the elastic layer so that the elastic layer covers and seals the actuation channel and wherein the actuation channel is configured to transmit positive or negative pressure to the elastic layer opposite a valve or pump in the fluidic structure;
b) a fluidic robot configured to deliver or remove fluid from the aperture;
c) a source of positive and/or negative pressure in communication with the actuation conduit; and
d) a control unit comprising logic to operate the fluidic robot and to actuate the valve.

14. A method comprising:
a) moving a non-microfluidic volume of a liquid from a first non-microfluidic compartment into a microfluidic channel and from the microfluidic channel into a second non-microfluidic compartment, wherein the first microfluidic compartment, the microfluidic channel and the second microfluidic compartment are in fluid communication with each other in an article fabricated in one piece.

15. A method comprising:
a) providing a fluidic circuit comprising a plurality of non-micro fluidic compartments in fluidic communication with a microfluidic channel in an article fabricated in one piece;
b) moving a non-microfluidic volume of a liquid comprising an analyte from a first non-microfluidic compartment through the microfluidic channel and into another non-microfluidic compartment;
c) moving a non-microfluidic volume of a liquid comprising a first reagent from one of the non-microfluidic compartments through the microfluidic channel and into the non-microfluidic compartment holding the analyte to form a first reaction mixture,
d) reacting the first reagent with the analyte to form a first product; and
e) moving a non-microfluidic volume comprising the first product from the non-microfluidic compartment through the microfluidic channel into another of the non-microfluidic compartments.

16. The method of claim 15 further comprising:
f) moving a non-microfluidic volume comprising the first product from the non-microfluidic compartment through the microfluidic channel into one of the non-microfluidic compartments;
g) moving a non-microfluidic volume of a liquid comprising a second reagent from one of the non-microfluidic compartments through the microfluidic channel and into the non-microfluidic compartment comprising the first product;
h) reacting the second reagent with the first product to form a second product; and
i) moving a non-microfluidic volume comprising the second product from the non-microfluidic compartment through the microfluidic channel into another of the non-microfluidic compartments.

17. The method of claim 15 further comprising:
f) moving a non-microfluidic volume comprising the first product from the non-microfluidic compartment through the microfluidic channel into a chamber comprising magnetically responsive particles adapted to bind the first product and binding the first product to the particles;
g) magnetically capturing the particles in the chamber;
h) washing the particles;
i) eluting the first product from the particles; and
j) moving a non-microfluidic volume comprising the eluted first product through the microfluidic channel into another of the non-microfluidic compartments.

18. A piece having a center of mass and comprising at least one microfluidic channel formed in a surface of the piece and at least one cavity in the surface defined by a wall, wherein the channel is in fluidic communication with the cavity, wherein a first draft angle defined by a first side of a wall of a cavity and an axis perpendicular to the surface is more oblique than a second draft angle defined by a second side of the wall of the cavity and the axis, wherein the first side is farther away from the center of mass than the second side.

19. A piece having a surface comprising a microfluidic channel and a relief, wherein the channel traverses the relief and a floor of the channel traversing the relief is inset deeper into the surface than a floor of the relief.

20. A piece having a surface, at least a portion of which is non-smooth, and at least one microfluidic channel formed in the non-smooth portion.
